(19) United States
(12) Patent Application Publication
(10) Pub. No.: US 2019/0284348 A1
(43) Pub. Date: Sep. 19, 2019

(54) METALLOPOLYMERS FOR ADDITIVE MANUFACTURING OF METAL FOAMS

(71) Applicant: Lawrence Livermore National Security, LLC, Livermore, CA (US)

(72) Inventor: William Compel, Oakland, CA (US)

(21) Appl. No.: 16/352,639

(22) Filed: Mar. 13, 2019

Related U.S. Application Data
(63) Continuation-in-part of application No. 15/921,360, filed on Mar. 14, 2018.

(51) Int. Cl. C08G 83/00; B33Y 70/00; C08J 9/00

(52) U.S. Cl. CPC C08G 83/001; C08J 2385/00; C08J 9/00; B33Y 70/00

(57) ABSTRACT

According to one inventive concept, a metallopolymer material includes a plurality of nanoparticles, a base, and water. Each of the nanoparticles includes a plurality of oligomer segments, where oligomer segments are coordinated to adjacent oligomer segments. Each of the oligomer segments includes a thiol and a metal.

The United States Government has rights in this invention pursuant to Contract No. DE-AC52-07NA27344 between the United States Department of Energy and Lawrence Livermore National Security, LLC for the operation of Lawrence Livermore National Laboratory.

### FIELD OF THE INVENTION

The present invention relates to additive manufacturing of metal foams, and more particularly, this invention relates to metallopolymers for additive manufacturing of metal foams and methods of making same.

### BACKGROUND

Additive manufacturing of metal-containing material has been challenging and expensive. A current method of additive manufacturing includes heating a metal to a liquid, extruding the liquid metal into a pattern, and then, the patterned liquid metal cools to a patterned solid metal. This method, however, involves continual high temperatures to maintain the metal as a liquid during the additive manufacturing process, and thus, lacks efficiency. Another applied manufacturing method to form metal-containing material involves projecting a laser beam onto a bed of metal powder to melt the metal powder or sinter the metal powder together. Subsequent layers are added by adding more powder followed by laser beam treatment to make the metal-containing material. This method, however, generates waste which is not recoverable. Both of these current methods of applied manufacturing of metal-containing material generate waste and use high levels of energy.

It would be desirable to develop a method of additive manufacturing to create a metal material that does not generate waste or use high levels of energy to process.

### SUMMARY

According to one inventive concept, a metallopolymer material includes a plurality of nanoparticles, a base, and water. Each of the nanoparticles includes a plurality of oligomer segments, where oligomer segments are coordinated to adjacent oligomer segments. Each of the oligomer segments includes a thiol and a metal.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1A is a schematic drawing of a metal coordination polymer, according to one inventive concept.

FIG. 1B is a schematic drawing of an organic polymer, according to one inventive concept.

FIG. 1C is a schematic drawing of a metallopolymer material, according to one inventive concept.

FIG. 1D is a schematic drawing of a proposed mechanism of assembly of a metallopolymer structure, according to one inventive concept.

FIG. 2 is a flow chart of a method of forming a metal foam with substantially uniform density, according to one inventive concept.

FIG. 3A is a schematic drawing of a method to form a sintered metal NP network with larger porosity, according to one inventive concept.

FIG. 3B is a schematic drawing of a method to form a sintered metal NP network with smaller porosity, according to one inventive concept.

FIG. 4 is a flow chart of a method of forming a metal foam with a graded density, according to one inventive concept.

FIG. 5 is a schematic drawing of a method to form a metal foam with a graded density, according to one inventive concept.

FIG. 6 is a flow chart of a method of forming a metallopolymer material, according to one inventive concept.

FIG. 7 is a schematic drawing of the effect of the concentration of water in the metallopolymer material, according to various aspects of inventive concepts described herein.

FIG. 8A is a plot of elastic moduli (G′) and viscosity moduli (G″) versus material mass % of water content, according to one inventive concept.

FIG. 8B is a plot of viscosity moduli of metallopolymer material over a range of moisture content, according to one inventive concept.

FIG. 8C is an annotated Ashby plot including metallopolymer material, according to one inventive concept.

FIG. 9 is an image by scanning electron microscopy of a metallopolymer material with a low moisture content.

FIG. 10A is a plot of XRD analysis of metallopolymer material, according to one inventive concept.

FIG. 10B is a plot of XRD analysis of wet and dry metallopolymer material, according to various aspects of one inventive concept.

FIG. 11A is plot of dynamic light scattering analysis of a metallopolymer material, according to one inventive concept.

FIG. 11B is a plot of gel permeation chromatography of a metallopolymer material, according to one inventive concept.

FIG. 12 is a plot of Fourier-transform infrared spectroscopy analysis of metallopolymer material, according to one inventive concept; part (a) represents wavenumbers 1700 to 1475 cm⁻¹, part (b) represents wavenumber 1475 to 1350 cm⁻¹.

FIG. 13 includes the results of Density functional theory (DFT) simulation studies of component of the metallopolymer material, according to various inventive concepts.

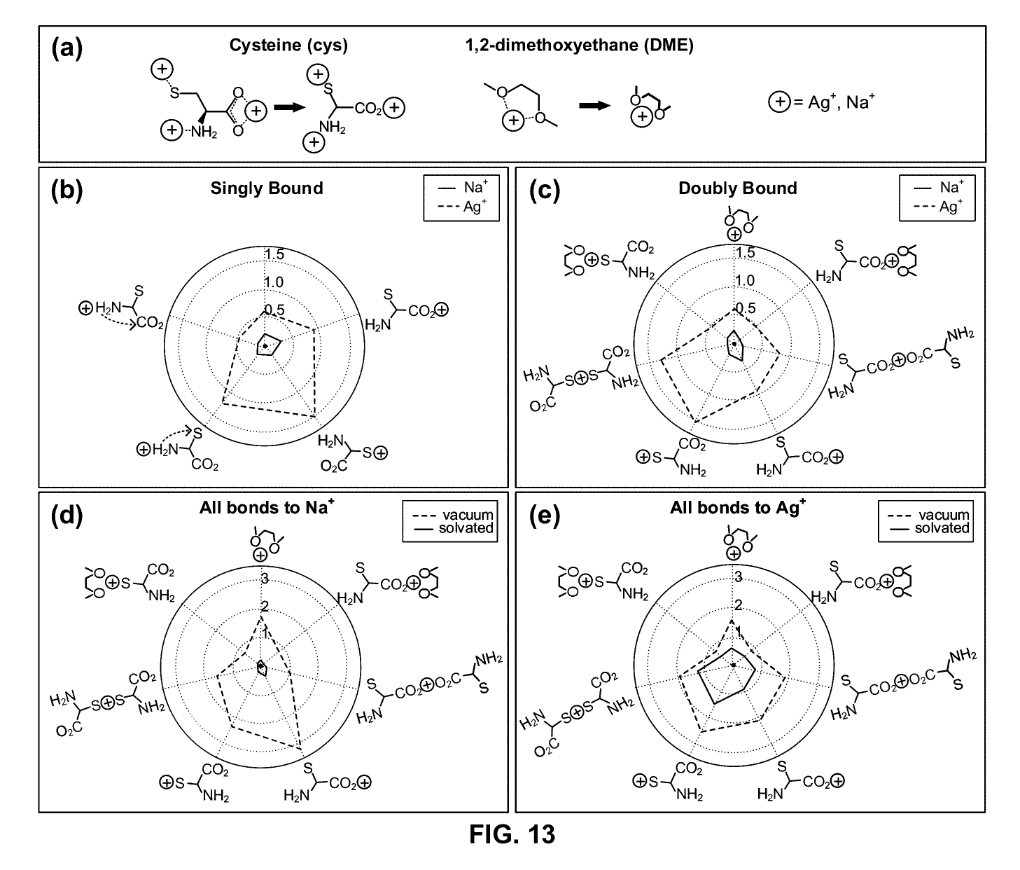

Part (a) of FIG. 13 depicts the molecular structures of cysteine and glyme (DME).

Part (b) of FIG. 13 is a graphical depiction of the predicted values listed in Table 2a.

Part (c) of FIG. 13 is a graphical depiction of the predicted values listed in Table 2b.

Part (d) of FIG. 13 is a graphical depiction of predicted BDE values of Na⁺ bonds in a vacuum and a solvated solution.

Part (e) of FIG. 13 is a graphical depiction of predicted BDE values of Ag⁺ bonds in a vacuum and a solvated solution.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

As also used herein, the term “about” denotes an interval of accuracy that ensures the technical effect of the feature in question. lip various approaches, the term “about” when combined with a value, refers to plus and minus 10% of the reference value. For example, a thickness of about 10 nm refers to a thickness of 10 nm±1 nm, a temperature of about 50° C. refers to a temperature of 50° C.±5° C., etc.

A nanoscale is defined as having a diameter or length less than 1000 nanometers (nm).

It is also noted that, as used in the specification and the appended claims, wt % is defined as the percentage of weight of a particular component is to the total weight/mass of the mixture. Mol % is defined as the percentage of moles of a particular component to the total moles of the mixture or compound. Atomic % (at %) is defined as a percentage of one type of atom relative to the total number of atoms of a compound.

The following description discloses metal foams formed from metallopolymer material and/or related systems and methods. For example, some inventive concepts described herein provide methods to process metals at a gel phase and then convert the formed metal gel-like structures to pure metal material.

In accordance with one general aspect of the presently disclosed inventive concepts, a metallopolymer material includes a plurality of nanoparticles, a base, and water. Each of the nanoparticles includes a plurality of oligomer segments, where oligomer segments are coordinated to adjacent oligomer segments. Each of the oligomer segments includes a thiol and a metal.

A list of acronyms used in the description is provided below.

| | |
|---|---|
| 2D | Two-dimensional |
| 3D | Three-dimensional |
| AIMD | Ab-Initio Molecular Dynamics |
| Ag | Silver |
| Au | Gold |
| BET | Brunauer-Emmett-Teller theory |
| CGC | Critical gel concentration |
| cm⁻¹ | per centimeter |
| COO⁻ | Carboxylic group |
| Cu | Copper |
| Cys | Cysteine |
| DIW | Direct ink write |
| DLS | Dynamic light scattering |
| DME | Dimethoxyethane |
| DOSY | Diffusion ordered spectroscopy |
| DSC | Differential scanning calorimetry |
| EM | Electron microscopy |
| FTIR | Fourier-transform infrared spectroscopy |
| GPa | Gigapascal |
| GPC | Gel permeation chromatography |
| HED | High energy density |
| ICP | Inductively coupled plasma |
| Na | Sodium |
| NH₂ | Amine group |
| NMR | Nuclear magnetic resonance |
| NPs | nanoparticles |
| NIF | National Ignition Facility |
| Pa | Pascal |
| PAGE | Polyacrylamide gel electrophoresis |
| Ppm | Parts per million |
| R | Functional side chain |
| RH | Relative humidity |
| S | Sulfur |
| TGA | Thermogravimetric analysis |
| Wt % | weight % |
| XRD | X-ray diffraction |

It will be appreciated that the compounds of various inventive concepts can contain asymmetrically substituted atoms, such as asymmetrically substituted carbon atoms, asymmetrically substituted sulfur atoms, asymmetrically substituted metal atoms, or any combination thereof. All chiral, diastereomeric, racemic forms and all geometric isomeric forms of a structure are part of this disclosure. For example, a metallopolymer composition can comprise an (R)-cysteine substituent, and (S)-cysteine substituent, or both.

As used herein, a “thiol” refers to an organic compound that includes at least one “—SH” group, which is typically a primary or secondary thiol group, and which can be used as a coinage metal ligand. The thiol can be a water-soluble thiol or organic-soluble thiol. Preferably, the thiol molecule also includes a carboxylic acid or amine moiety.

Examples of suitable water-soluble thiols include, but are not limited to, glutathione, cysteine, captopril, thiomalic acid (mercaptosuccinic acid), N-(2-mercaptopropionyl)glycine, p-mercaptobenzoic acid, m-mercaptobenzoic acid, penicillamine, (C₂-C₇)mercaptoalkanoic acids such as 6-mercaptohexanoic acid, and the like.

Examples of suitable organo-soluble thiols include, but are not limited to, 2-phenylethanethiol (PET), 1-phenylethanethiol, benzyl mercaptan, thiophenol, (C₁-C₁₈)alkylthiols such as methanethiol, isopropyl thiol, t-butyl thiol, hexanethiol and dodecanethiol, (C₈-C₁₈)mercaptoalkanoic acids such as 11-mercaptoundecanoic acid, (C₃-C₈)mercaptocycloalkanes such as cyclohexanethiol, dimercaptosuccinic acid, 2-mercaptoethanol, 3-mercaptopropanol, 3-mercaptopropane-1,2-diol (2,3-dihydroxypropyl-mercaptan; thioglycerol), 1-adamantanethiol, 1-naphthalenethiol, 2-naphthalenethiol, camphorthiol, and the like. Some organo-soluble thiols such as those having a carboxylic acid functionality may become water soluble at high pH (e.g., above about 7, above about 7.5, or above about 8). Organo-soluble thiol derivatives having carboxy or amino functionalities related to the thiols of this paragraph are commercially available or can be prepared synthetically, for use as the thiols of the compositions described herein.

Thiolates typically comprise about 1-30 carbon atoms and may have a wide variety of functional or substituent groups such as oxo (e.g., carbonyl, aldehyde, or ketone) moieties, carboxylic acids, anhydride moieties, ester moieties, amide moieties, cyano, nitro, inorganic acid derivatives (e.g., phospho and boro acids and derivatives) and their sulfur and amino analogs, including I°, II°, III°, and IV° amines, zwitterionic moieties, and various substituents where the substituents may be hydrocarbon or substituted hydrocarbon, as well as carbocyclic and heterocyclic, with functional groups coming within the groups set forth above, as well as nitrogen derivatives, such as azo, azoxy, and diazo, organic and inorganic salts of the above ions, and the like. Complex thiolates may be used, both naturally occurring and synthetic, including oligomers, e.g., oligopeptides, of from about 2 to 30 units, thio analogs of purines, pyrimidines, nucleotides and nucleosides, aptamers, and amide linked nucleic acid analogs.

As used herein, the term “glyme” refers to a glycol ether. One representative example is dimethoxyethane. “Diglyme” refers to diethylene glycol dimethyl ether. Additional glymes include triglyme (triethylene glycol dimethyl ether) and tetraglyme (tetraethylene glycol dimethyl ether).

Glycol ethers can have, for example, a hydroxyl group, an alkyl group, or an ester group as a terminal group, while the other terminal group is typically an alky or phenyl group, but can also be a hydroxyl group. Glymes further include polyethylene glycols of various lengths.

Various inventive concepts described herein combine organic and inorganic components at a molecular level to allow metals to be processed like plastics. Furthermore, methods using these materials are advantageous in additive manufacturing because the methods enable low-cost and rapid manufacturing of entire functional devices that depend on a metal structure.

Various inventive concepts described herein include metallopolymer materials that may be synthesized in various forms, such as, but not limited to a gel, dried to a powder, cast into a mold, deposited as a thin film, extruded into a three-dimensional (3D) structure, etc. and may retain unique metallic behavior such as fluorescence, conductivity, catalytic activity, anti-microbial activity, etc.

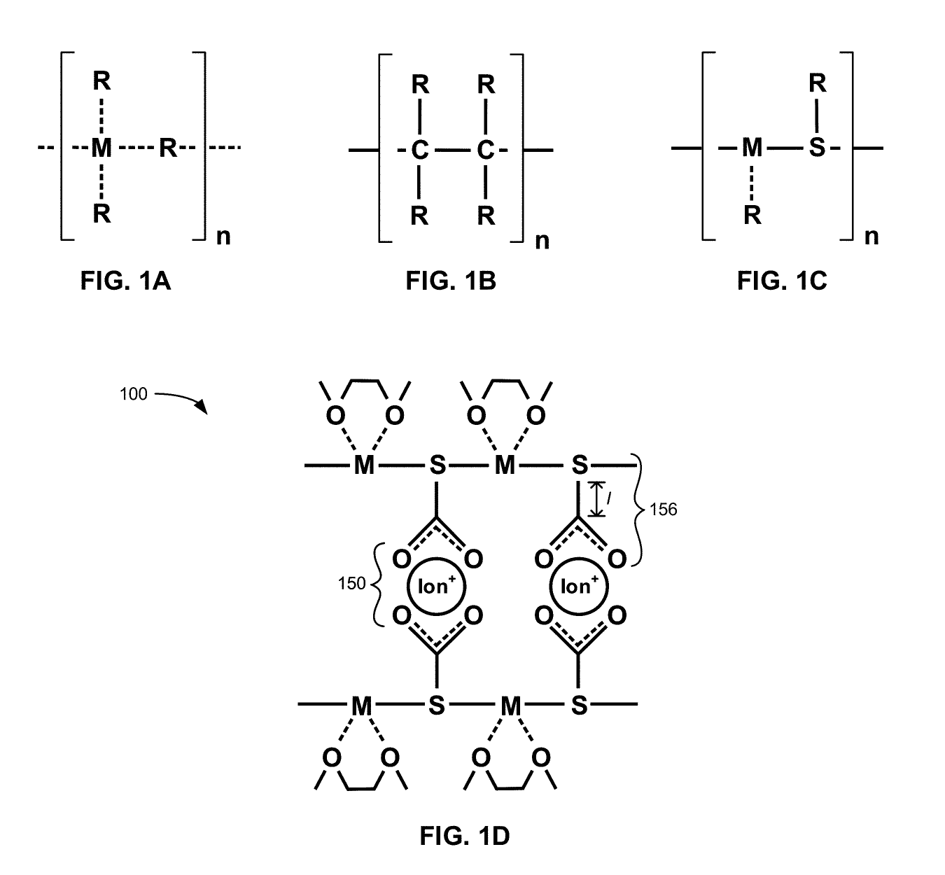

Various inventive concepts described herein use methodology disclosed in U.S. patent application Ser. No. 15/368,232 which is herein incorporated by reference. In brief, the methodology describes a process for creating a metallopolymer material (FIG. 1C) that includes metal coordination polymers (FIG. 1A) where M is a metal with physically bound side chains of polymers coordinated with M. The metallopolymer material also includes organic polymers (FIG. 1B) with covalently bound side chains. The metallopolymer material may have the processing capability of polymers while maintaining metallic characteristics.

In one inventive concept, the metallopolymer material has a molecular structure that includes a metal-thiolate backbone (-M-S-, FIG. 1C) with covalently bound side chains (solid line, S-R) and physically bound side chains (dashed line, M - - - R). The covalently bound side chains may provide adaptability for adjustable static properties much like organic polymers, e.g. varying chain length, varying chain flexibility, etc. The physically bound side chains may enable a dynamic bonding environment that renders the material environmentally responsive, e.g. the material possess correct rheology for shear thinning, define bulk material stiffness, etc. Without wishing to be bound by any theory, it is believed that the physically bound side chains may serve as built-in plasticizer to modulate the structural rigidity of a functional metallopolymer.

FIG. 1D depicts a schematic representation of a mechanism to create a metallopolymer material 100 that includes ionic bridges 150 and pre-defined polymeric chain length of the thiol ligand 156. According to one inventive concept, the metallopolymer segments may perform like plasticizers, as depicted in FIG. 1D, with oxygen O atoms forming physical bonds with the metal M atoms of the M-S backbone thereby bolstering one side of the metallopolymer segments; and on the other side of the metallopolymer segments, the thiol ligands 156 provide a site for ionic assembly, as shown with association with sodium ions (Na⁺). Furthermore, the length and flexibility of the covalently bound polymeric chain of the thiol ligand 156 may also affect the ionic conductivity of the ionic bridge 150.

In various inventive concepts, the ionic conductivity of the metallopolymer material may be tuned based on two factors as shown in FIG. 1D: the strength of the ionic bridge 150 interaction and the flexibility of the polymeric chain of the thiol ligands 156. These two factors may be independently assessed by controlling chemical identity, chain length, and rigidity of the metallopolymer network in silico, i.e., by computer simulation, as discussed further below. In various inventive concepts described herein, the tunable ionic conductivity of the metallopolymer material may translate into pre-determined tunable ionic conductivity of metal foam formed from the metallopolymer material.

According to one inventive concept, the metallopolymer network formed with metallopolymer material may exhibit unique behavior such as ionic conductivity and remarkably high storage modulus that is higher than the sum of the component properties (metal coordination polymers in FIG. 1A and organic polymers in FIG. 1B).

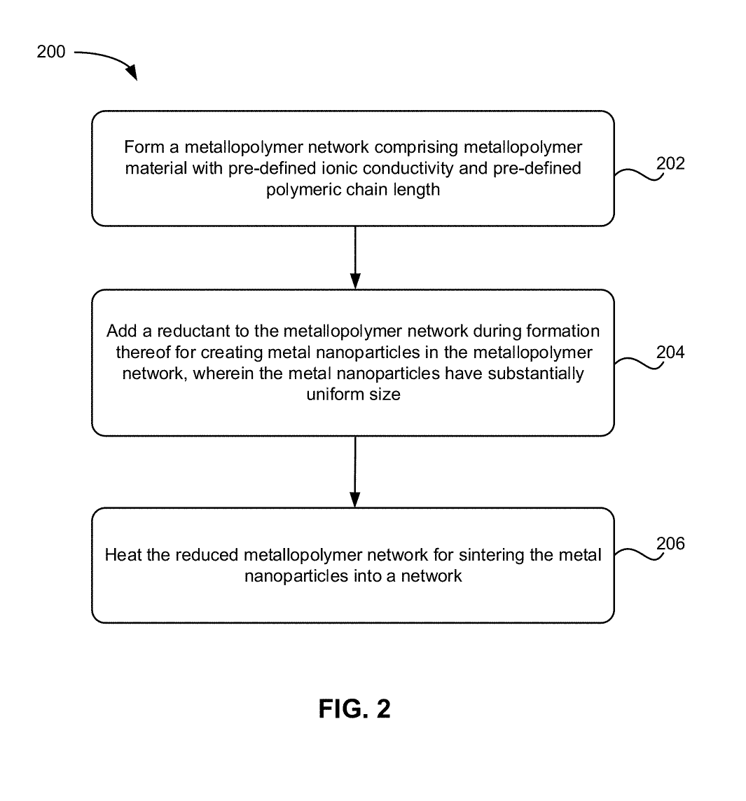

FIG. 2 shows a method 200 for forming a metal foam with substantially uniform density, in accordance with one inventive concept. As an option, the present method 200 may be implemented to structures such as those shown in the other FIGS. described herein. Of course, however, this method 200 and others presented herein may be used to form structures for a wide variety of devices and/or purposes which may or may not be related to the illustrative inventive concepts listed herein. Further, the methods presented herein may be carried out in any desired environment. Moreover, more or less operations than those shown in FIG. 2 may be included in method 200, according to various inventive concepts. It should also be noted that any of the aforementioned features may be used in any of the inventive concepts described in accordance with the various methods.

FIG. 2 graphically depicts steps in a method 200 of forming a metal foam with substantially uniform density. In some approaches, the method may form metal foams with substantially uniform density, for example, but not limited metal foams of Au, Ag, copper (Cu), etc. with substantially uniform density. The method begins with step 202 involving forming a metallopolymer network including metallopolymer material with pre-defined ionic conductivity and pre-defined average polymeric chain length. The metallopolymer material may include a metal, a thiol, and a glyme.

In an exemplary approach, a ratio of the thiol to the metal at a same concentration may be at least three % vol thiol to 1% vol metal. In various approaches, the ratio of thiol to metal may be a molar ratio of 1 metal to 3 thiol.

In various approaches, the metal may be a coinage metal. For example, but not intended to be limiting, the coinage metal may be Au, Ag, Cu, etc. In some approaches, the metal may be a combination of metals. For example, but not intended to be limiting, the metal may be a combination of coinage metals.

In some approaches, the metal may be tin, platinum, palladium, titanium, aluminum, etc.

In various approaches, the glyme may be defined as a glycol ether, a glycol diether, and any version thereof as described in the beginning of this section. In a preferred approach, a volume ratio may be 1 unit metal (100 mM) to 6 units glyme (pure) may depend on the molecular weight of each glyme. In some approaches, the glyme may be in the range of about 100 to about 200 equivalents of polyethylene glycol dimethyl ether (glyme) to one equivalent of metal. The concentration of pure glyme, for example mono-, di-tri-, tetra-, pentaglyme, etc., may depend on the molecular weight of the glymes.

Looking back to FIG. 1D, in some approaches, the ionic conductivity may be tuned by the strength of an ionic bridge 150 formed between two polymeric side chains of opposing thiol ligands 156 in a metallopolymer material 100. In some approaches, the ionic conductivity may be tuned by varying the length l of the polymeric side chain length of the thiol ligand 156. In some approaches, the ionic conductivity may be tuned by varying the flexibility of the polymeric side chain of the thiol ligand 156. In some approaches, the ionic conductivity may be tuned by the strength of the ionic bridge 150 interaction. In some approaches, determinations of polymeric side chain length of the thiol ligands 156 and ionic bridge 150 interaction may involve performing Ab-Initio Molecular Dynamic (AIMD) simulations of lithium (Li⁺) and sodium (Na⁺) ion conductivity in which ab initio methods provide simulations of breaking or formation of covalent bonds and the electronic states associated with functions. In some approaches, any cation may be substituted, for example, but not limited to, potassium (K⁺), calcium (Ca²⁺), ammonium (NH₄⁺), etc.

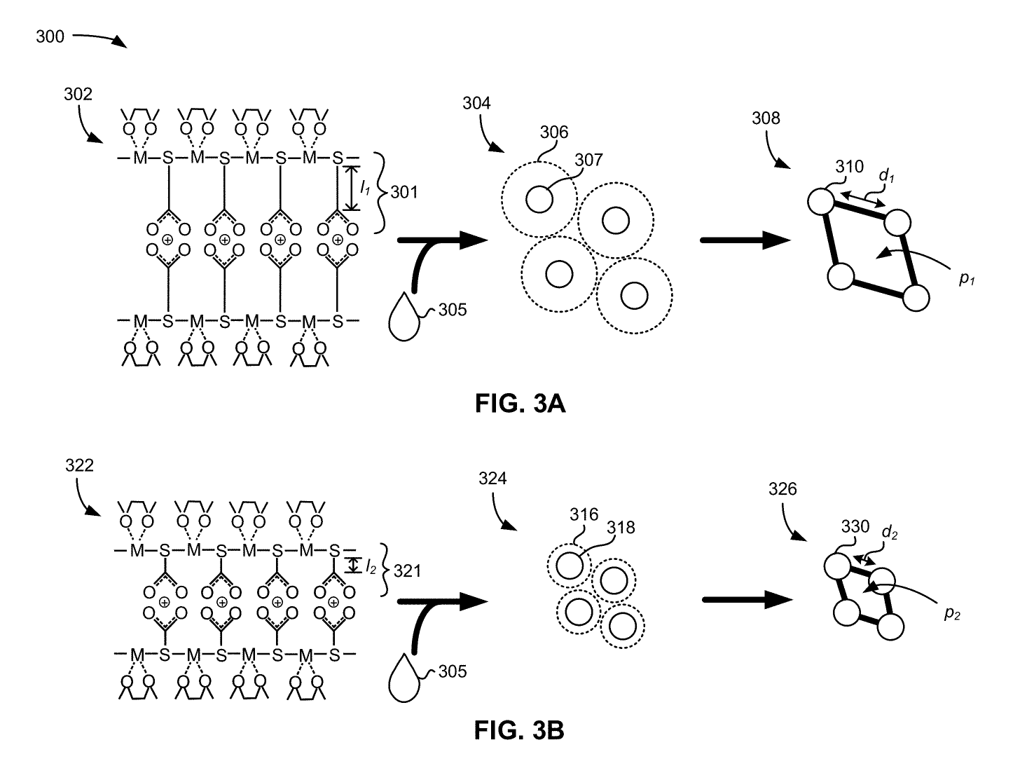

In some approaches, the average polymer side chain length l may be defined by adjusting pH. In other approaches, thiols may be purchased with various polymer side chain length l of the thiol ligands 156 and used for creating the metallopolymer material 100. In some approaches, a length l of the average polymeric side chain of the thiol may determine the nanoparticle spacing in the reduced metallopolymer network, and subsequently the distance d₁ between the nanoparticle remnants 310 in sintered metal foam 308 (FIG. 3A) and distance d₂ between the nanoparticle remnants 330 in sintered metal foam 326 (FIG. 3B). Thus, in turn, the porosity of the final sintered structure may be controlled by the length of the average polymeric side chain.

In some approaches, the thiol of the metallopolymer material may be glutathione. In other approaches, the thiol of the metallopolymer material may be cysteine. In yet other approaches, the thiol of the metallopolymer material may be thiomalic acid.

Step 204 includes adding a reductant to the metallopolymer network during formation thereof for creating metal nanoparticles in the metallopolymer network. Further, the metal nanoparticles in the metallopolymer network may have substantially uniform size (e.g., average diameters within 5% of the median diameter). In some approaches, step 204 may include controlling a concentration of a reductant to result in a particular diameter of metal nanoparticles in the reduced metallopolymer network.

The printed metallopolymer network by applied manufacturing may be a printed three-dimensional (3D) structure. In some approaches, the metallopolymer ink may be extruded through a nozzle using a Direct Ink Writing (DIW) method of applied manufacturing to form a metallopolymer network. In other approaches, the metallopolymer ink may be printed using projection microstereolithography to form a metallopolymer network.

The metallopolymer material as shown in FIG. 1D may be used as an ink without additives to optimize rheology for DIW fabrication. The nature of the weak physically bound side chains coordinated to the M of the metal-thiolate backbone (-M-S-) allows shear thinning and the flexibility and length of the covalently bound side chains of the thiol ligand 156 controls bulk material stiffness. Furthermore, these features may function as a built-in plasticizer in the metallopolymer material and provide optimal modular rheology for applied manufacturing processes.

According to method 200 of forming a metal foam with substantially uniform density, step 204 may involve simultaneous reduction of the forming metallopolymer network to a network of substantially uniform metal nanoparticles (NPs). In some approaches, step 204 may involve forming a metallopolymer network in the presence of a reductant to reduce the forming metallopolymer network into a reduced metallopolymer network of metal nanoparticles having substantially uniform size. In some approaches, the reductant may be added to the metallopolymer as a mixture for an ink. In other approaches, the reductant may be added as a component during extrusion of the metallopolymer material into a metallopolymer network.

Reduction techniques known by one skilled in the art may be used and optimized for the specific metal of the metallopolymer network. Any suitable reductant may be used that would be apparent to one skilled in the art upon reading the current disclosure. For example, but not meant to be limiting, in some approaches step 204 may involve using a sodium borohydride reductant to reduce the forming gold (Au) metallopolymer network into a metallopolymer network of substantially uniform Au NPs. Another example, that is not meant to be limiting, may include reducing a forming silver (Ag) metallopolymer network into a metallopolymer network of substantially uniform Ag NPs with the reducing effects of laser beam technology known by one skilled in the art.

Step 206 of method 200 includes heating the reduced metallopolymer network for sintering the metal nanoparticles into a network of metal nanoparticles. In some approaches, sintering the metal nanoparticles of the metallopolymer network removes the organic material (e.g. polymer) and melts the metal NPs together into a metal foam. The techniques of sintering the metallopolymer network of metal nanoparticles may involve conventional sintering techniques known by one skilled the art.

FIGS. 3A-3B illustrate a schematic diagram of a method 300 for forming a metal foam with substantially uniform density from a single material, in accordance with one inventive concept. As an option, the present method 300 may be implemented to construct structures such as those shown in the other FIGS. described herein. Of course, however, this method 300 and others presented herein may be used to form structures for a wide variety of devices which may or may not be related to the illustrative inventive concepts listed herein. Further, the processes presented herein may be carried out in any desired environment. Moreover, more or less operations than those shown in FIGS. 3A-3B may be included in method 300, according to various inventive concepts. It should also be noted that any of the aforementioned features may be used in any of the inventive concepts described in accordance with the various methods and processes.

According to some inventive concepts, forming a metal structure with substantially uniform density, e.g. a metal foam, includes forming a metallopolymer network with metallopolymer material including a thiol ligand having a polymeric side chain of pre-defined length in the presence of a reductant. In various approaches, a process of forming a metal structure with uniform density may include a simultaneous addition of a reductant during the formation of a metallopolymer network. FIGS. 3A and 3B illustrate a process as described in method 200 of FIG. 2, such that FIG. 3A illustrates a starting metallopolymer material with a thiol ligand 301 having a polymeric side chain of pre-defined length l₁, and FIG. 3B illustrates a starting metallopolymer material with a thiol ligand 321 having a polymeric side chain of pre-defined length l₂.

FIG. 3A illustrates forming a metal structure with substantially uniform density starting with a metallopolymer material 302 with a thiol ligand 301 having a polymeric side chain of pre-defined length l₁. In various inventive concepts, the components of the metallopolymer material may be altered to define the structure-property relationships of the metallopolymer material. According to a method 300 similar to the stepwise method 200 in FIG. 2, a reductant 305 may be added simultaneously during formation of the metallopolymer network thereby resulting in a reduced metallopolymer network 304 of nanoparticles having substantially uniform size.

FIG. 3B illustrates forming a metal structure starting with a metallopolymer material 322 with a thiol ligand 321 having a polymer side chain of pre-defined length l₂ that is a different length than l₁ of the polymer side chain of a thiol ligand 301 of the metallopolymer material 302 in FIG. 3A.

As shown in both FIGS. 3A and 3B, adding reductant 305 while forming the metallopolymer network with the metallopolymer material 302, 322 may simultaneously grow metal nanoparticles 307, 318 to a substantially uniform size and trap the nanoparticles 307, 318 in the thiolates 306, 316 of the resulting reduced metallopolymer network 304, 324, according to various inventive concepts. For example, but not meant to be limiting, reducing a cationic Au in an Au metallopolymer forms a zero-valent Au NP core encapsulated by thiolates. The Au core may continue to grow for as long as the reductant is present in the system. The reduced metallopolymer network 304, 324 may include metal NPs of substantially uniform size.

Following the formation of a reduced metallopolymer network with metal NPs, the method 300 includes sintering the reduced metallopolymer network 304, 324 to form the final sintered metal foam 308, 326 with fine control of porosity and density of the metal foams. In some approaches, the temperature for sintering the reduced metallopolymer network may be at an effective temperature to remove organic material of the network and to coalesce the particles in the network to a metal foam. In some approaches, the temperature for sintering may be in a range of about 150° C. to about 300° C.

In FIG. 3A, sintering the reduced metallopolymer network 304 may result in a sintered metal foam 308 having substantially uniform porosity with an average pore size p₁ that may be defined from the sintered remnants 310 of the metal nanoparticles 307 and a distance d₁ between the sintered remnants 310. Moreover, the distance d₁ between the sintered remnants 310 may correspond to a relative length l₁ of the polymeric side chain of the thiol ligand 301 of the starting metallopolymer material 302.

Likewise, in FIG. 3B, sintering the reduced metallopolymer network 324 may result in a sintered metal foam 326 having a substantially uniform porosity with an average pore size p₂ that may be defined from the sintered remnants 330 of the metal nanoparticles 318 and a distance d₂ between the sintered remnants 330. Moreover, the distance d₂ between the sintered remnants 330 may correspond to the relative length l₂ of the polymeric side chain of the thiol ligand 321 of the starting metallopolymer material 322.

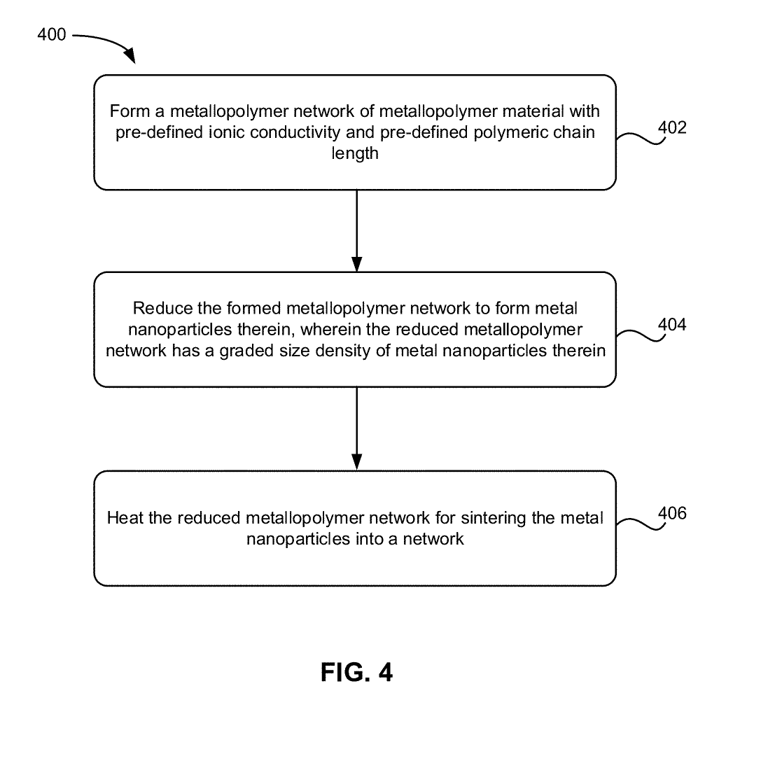

FIG. 4 shows a method 400 for forming a metal foam with graded density, in accordance with one inventive concept. As an option, the present method 400 may be implemented to structures such as those shown in the other FIGS. described herein. Of course, however, this method 400 and others presented herein may be used to form structures for a wide variety of devices and/or purposes which may or may not be related to the illustrative inventive concepts listed herein. Further, the methods presented herein may be carried out in any desired environment. Moreover, more or less operations than those shown in FIG. 4 may be included in method 400, according to various inventive concepts. It should also be noted that any of the aforementioned features may be used in any of the inventive concepts described in accordance with the various methods.

In the method 400, a metal foam with graded density may be formed from a metallopolymer network with a gradient of different sizes of metal nanoparticles. In some approaches, the method 400 may form a metal foam with graded density. Method 400 includes a process in which a metallopolymer network is formed from a metallopolymer material, and then a reducing agent is introduced post-formation. In some approaches, the method may form metal foams with graded density, for example, but not limited to metal foams of Au, Ag, Cu, etc. with graded density.

Looking to FIG. 4, method 400 begins with step 402 involving forming a metallopolymer network of metallopolymer material with pre-defined ionic conductivity and pre-defined average polymeric chain length. The metallopolymer material may include a metal, a thiol, and a glyme. In an exemplary approach, a ratio of the thiol to the metal at a same concentration may be at least three % vol thiol to 1% vol metal (e.g. 3:1). Further, a ratio of glyme to a metal of a same concentration may be at least 100% vol glyme to 1% vol metal (e.g. 100:1) In various approaches, the metal may be a coinage metal, for example, but not limited to Au, Ag, Cu, etc. In some approaches, the metal may be a combination of metals, for example, a combination of coinage metals.

In various approaches, the glyme may be defined as a glycol ether, a glycol diether, and any version thereof as described in the beginning of this section. In a preferred approach, the glyme may be in the range of about 100 to about 200 equivalents of polyethylene glycol dimethyl ether (glyme) to one equivalent of metal. The amount of various glymes, for example mono-, di-tri-, tetra-, pentaglyme, etc. may depend on the molecular weight of the glymes.

Looking back to FIG. 1D and as discussed in the above section, in some approaches, the ionic conductivity may be tuned by the strength of an ionic bridge 150 formed between two polymeric side chains of opposing thiol ligands 156 in a metallopolymer material 100.

In some approaches, the metallopolymer network may be formed by printing an ink, where the ink includes the metallopolymer material. Further, the formed metallopolymer network may be a printed three-dimensional structure. The printed metallopolymer network may be formed by applied manufacturing. In some approaches, the metallopolymer ink may be extruded through a nozzle using a DIW method of applied manufacturing to form a metallopolymer network. In other approaches, the metallopolymer ink may be printed using projection microstereolithography to form a metallopolymer network.

In some inventive concepts, the metallopolymer material may form a metallopolymer network that has pre-defined physical properties. In some approaches, the physical property of the formed metallopolymer network may be structural coloration, where structural coloration is defined by the production of color by microscopically structured surfaces fine enough to interfere with visible light. In some approaches, the physical property of the formed metallopolymer network may be that the formed metallopolymer network is electrically conductive.

Step 404 includes reducing the formed metallopolymer network to form metal nanoparticles therein, where the reduced metallopolymer network may have a graded size density of metal nanoparticles therein. In some approaches, reductant is introduced to the surface of the 3D structure of the metallopolymer network and allowed to diffuse slowly through the structure. In so doing, the diffusion of reductant may create a concentration gradient in which higher concentrations of reductant form larger metal nanoparticles. In various approaches, metal nanoparticle size may be tuned along this gradient by varying the reductant concentration.

Reduction techniques known by one skilled in the art may be used and optimized for the specific metal of the metallopolymer network. Any suitable reductant may be used that would be apparent to one skilled in the art upon reading this disclosure. In some approaches, a chemical reductant specific for reducing a particular metal may be introduced to the metallopolymer network. For example, but not meant to be limiting, in some approaches step 404 may involve using a sodium borohydride reductant to reduce the gold (Au) metallopolymer network into a network of Au NPs with graded density. In other approaches, non-chemical techniques may be used as a specific reductant to reduce a particular metal. An example, that is not meant to be limiting, may include reducing a silver (Ag) metallopolymer network into a network of Ag NPs with graded density using laser beam technology known by one skilled in the art.

Various approaches described herein may allow tuning of NP size by varying the reductant concentration. The size distribution of metal NPs in the network may be confirmed using polyacrylamide gel electrophoresis (PAGE) for rapid confirmation of monodispersity and electron microscopy (EM) and dynamic light scattering for quantification of size distribution.

In some approaches, the formed metal nanoparticle network may be electrically conductive.

Step 406 of method 400 includes heating the reduced metallopolymer network for sintering the metal nanoparticles into a network. In some approaches, the sintering techniques of the metal NPs may allow fine control of porosity and density of the metal foams. In some approaches, sintering the metal NP network removes the polymer and melts the metal NPs together into a metal foam. The techniques of sintering the metal nanoparticle network may involve conventional sintering techniques known by one skilled the art.

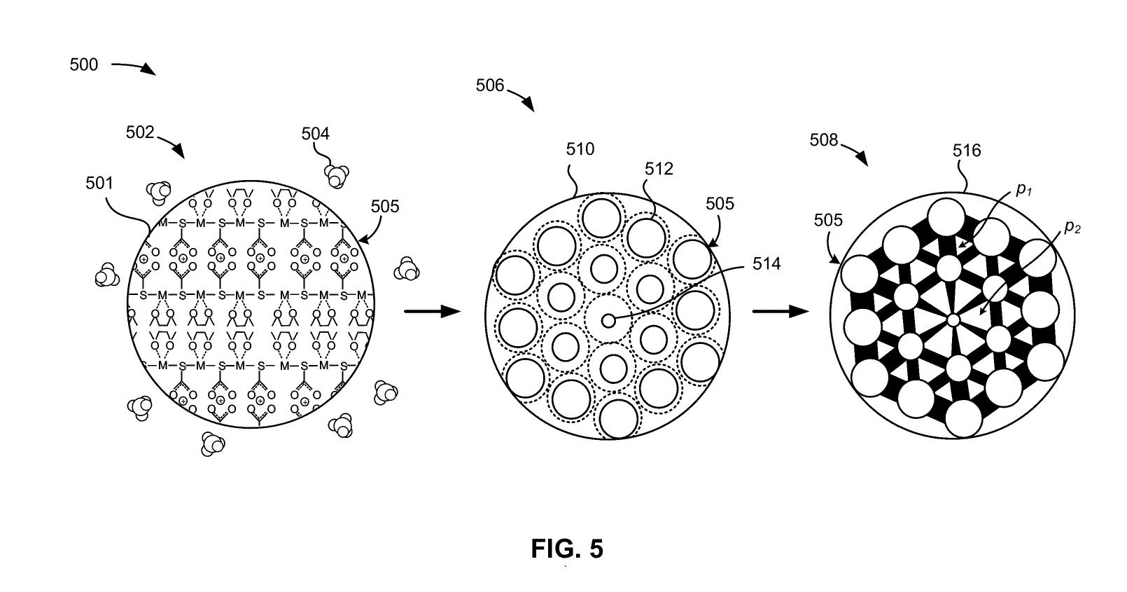

FIG. 5 illustrates a schematic diagram of a method 500 for forming a metal foam with graded density, in accordance with one inventive concept. As an option, the present method 500 may be implemented to construct structures such as those shown in the other FIGS. described herein. Of course, however, this method 500 and others presented herein may be used to form structures for a wide variety of devices which may or may not be related to the illustrative inventive concepts listed herein. Further, the methods presented herein may be carried out in any desired environment. Moreover, more or less operations than those shown in FIG. 5 may be included in method 500, according to various inventive concepts. It should also be noted that any of the aforementioned features may be used in any of the inventive concepts described in accordance with the various methods and processes.

According to some inventive concepts, a process of forming a metal structure with graded density may include forming a metallopolymer network followed by an addition of a reductant to reduce the formed metallopolymer network. In various approaches, the solid metallopolymer material may be reduced post-formation to form a metal NP size gradient in the reduced metallopolymer network. FIG. 5 illustrates the stepwise method 400 shown in FIG. 4. According to one inventive concept, step 502 of method 500 includes forming a metallopolymer network 501 from a metallopolymer material. In some approaches, the metallopolymer network may be printed as a 3D structure using applied manufacturing techniques.

Following formation of a structure of the metallopolymer network 501, a reductant 504 may be added to the metallopolymer network 501. In some approaches, the reductant 504 may be introduced at the surface 505 of the metallopolymer network 501 to slowly diffuse through the metallopolymer network. As reductant 504 diffuses through the structure of metallopolymer network 501, the reduced metallopolymer network 510 nucleates and grows metal NPs 512. A concentration gradient of the reductant may form where higher concentrations of reductant nearer the surface 505 of the structure of reduced metallopolymer network 510 may form larger metal NPs 512; and lower concentrations of reductant further from the surface 505 of the structure of the reduced metallopolymer network 510 may form smaller metal NPs 514.

In some approaches, the particle size may be tuned by varying reductant concentration. In some approaches, ion transport properties may be modeled through simulation to provide fine control over reductant diffusion through the material. During the reduction treatment of step 506, the structure of the reduced metallopolymer network 510 may form a structure of a network of NPs 514, 512, etc. with graded size density.

In step 508 the structure of the reduced metallopolymer network 510 of metal NPs 512, 514, etc. may be sintered to form a metal foam 516 with graded density. In some approaches, the metal foam 516 may be characterized by a continuous network. In some approaches, sintering the reduced metallopolymer network 510 may result in a sintered metal foam 516 having a graded density with an average pore size pi near the surface 505 that may increase in size to an average pore size p₂ further from the surface where smaller metal nanoparticles 514 formed in the reduced metallopolymer network 510 before sintering.

Conventional methods of sintering may be used to sinter distributed metal NPs 512, 514 into a mesoporous metal foam 516. In some approaches, the mesoporous foam may be an Au foam. The sintering process may include differential scanning calorimetry (DSC) and thermogravimetric analysis (TGA) to determine the temperature at which particles fuse, which may be ca. 150° C., but may be higher or lower.

According to one inventive concept, a metal foam includes a nanoporous metal structure, where the metal structure has physical characteristics of formation by three-dimensional printing of an ink that includes a metallopolymer material. In some inventive concepts, the metal foam may have a substantially uniform density throughout, as depicted in structures of sintered metal foam 308, 326 of FIGS. 3A and 3B, respectively. In some approaches, the metal foam may have substantially uniform porosity. In some approaches, the metal foam 308, 326 may have substantially uniform spacing throughout, where the spacing may be defined by metal nanoparticles 307, 318 before sintering the reduced metallopolymer network 304, 324.

In some inventive concepts, the metal foam may have a graded density as shown in the sintered metal foam 516 in FIG. 5. In some approaches, the metal foam 516 may have a graded density with an average porosity increasing from an outer surface of the metal foam toward an innermost portion thereof.

In some approaches, the metal foam may have nanopores with a diameter of nanometer scale. In one approach, a nanoporous structure may be defined as being microporous, where the diameter of the pores are in a range of about 0.2 nm to about 2 nm. In another approach, a nanoporous structure may be defined as being mesoporous, where the diameter of the pores are in a range of about 2 nm to about 50 nm. In yet another approach, a nanoporous structure may be defined as being macroporous, where the diameter of the pores are in a range of about 50 nm to about 1000 nm. In another approach, a nanoporous structure has nanopores with a diameter of about 0.2 nm to about 100 nm. In yet other approaches, a nanoporous structure may be defined as having a combination of being macroporous, mesoporous, and/or microporous.

The metal foam formed by methods described herein of forming a 3D structure of a metallopolymer network formed from an ink of metallopolymer material may have physical characteristics of formation by 3D printing that includes ridges along one surface of the metal foam characteristic of extrusion from a nozzle. In some approaches, the metal foam may have ridges along one surface of a metal foam with substantially uniform density. In other approaches, the metal foam may have ridges along one surface of a metal foam with graded density.

In some approaches, the continuous network resistance may be verified to reach ca. 1Ω, a value that may be close to the value of bulk metal conductivity, for example bulk Au conductivity.

In some approaches, surface area of the metal foam may be quantified with Brunauer-Emmett-Teller (BET) theory. In other approaches, the porosity of the metal foam may be assed with EM. Parameters of the metal foam, including density and porosity, may be tuned by adjusting the sintering temperature, the duration of heat exposure during sintering, NP core size, thiol chain length, etc. In yet other approaches, parameters of the metal foam may be tuned using more robust chemical sintering techniques.

In some inventive concepts, the formation of metal foam may include Au, Ag, and Cu systems. In some approaches, the metal foam may be at least 98% pure gold (Au). In other approaches, the metal foam may be at least 98% pure silver (Ag). In yet other approaches, the metal foam may be at last 98% pure copper (Cu). In yet other approaches, the metal foam may include a combination of metals.

Metallic soft materials, e.g., metallopolymers and metallogels, tend to have bulk mechanical properties that are characteristic of the secondary structures that self-assemble according to the building blocks of the metallic soft material. For example, a metallopolymer may form two-dimensional (2D) sheets, and the mechanical properties of the material may reflect the mechanical properties of a plurality of 2D sheets. Thus, by tuning the building blocks of the metallopolymer, and in turn, the pattern of self-assembly of the building blocks, the mechanical properties of the resulting metallopolymer structure may be fine-tuned for any specific application.

In typical processes of forming a metallopolymer, coinage metals react with thiols to form metallopolymers of 1:1 M(I):SR stoichiometry. The metallopolymer components may self-assemble laterally into two-dimensional (2D) sheets that may stack in a third dimension into microstructures, e.g., microscale plates, fibers, etc. The microstructures form through metallophilic (M-M) interactions to possibly trap solvent within the microstructures, thereby forming hydrogels, e.g., metallophilic hydrogels.

In one aspect of an inventive concept, a metallopolymer material includes a thiol, a base, a metal, and water. In some approaches, a concentration of the water may be in a range of greater than 0 wt % of total material and less than 99 wt % of total material.

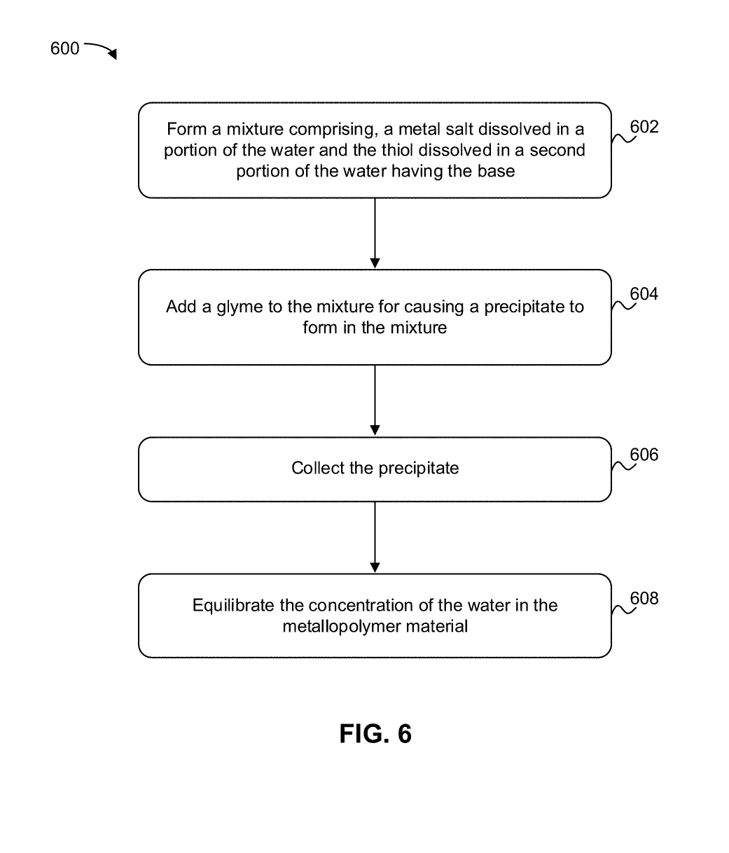

FIG. 6 shows a method 600 for forming a metallopolymer material, in accordance with one inventive concept. As an option, the present method 600 may be implemented to structures such as those shown in the other FIGS. described herein. Of course, however, this method 600 and others presented herein may be used to form structures for a wide variety of devices and/or purposes which may or may not be related to the illustrative inventive concepts listed herein. Further, the methods presented herein may be carried out in any desired environment. Moreover, more or less operations than those shown in FIG. 6 may be included in method 600, according to various inventive concepts. It should also be noted that any of the aforementioned features may be used in any of the inventive concepts described in accordance with the various methods.

Method 600 begins with step 602 of forming a mixture that includes a metal salt dissolved in a portion of the water and a thiol dissolved in a portion of the water having a base. In some approaches, the metal salt may be dissolved in the water followed by the base, and finally the thiol. A base is preferably included for solubility of the thiol in water. In various approaches, illustrative examples of bases include sodium hydroxide (NaOH), potassium hydroxide (KOH), ammonium hydroxide (NH₄OH), lithium hydroxide (LiOH), etc.

In an exemplary approach, a ratio of the thiol to the metal at a same concentration may be at least three % vol thiol to 1% vol metal. In various approaches, the ratio of thiol to metal may be a molar ratio of 1 metal to 3 thiol.

In various approaches, the metal may be a coinage metal. For example, but not intended to be limiting, the coinage metal may be Au, Ag, Cu, etc. In some approaches, the metal may be a combination of metals. For example, but not intended to be limiting, the metal may be a combination of coinage metals.

In some approaches, the metal may include tin, platinum, palladium, titanium, aluminum, etc.

In some approaches, the thiol may include glutathione, cysteine, thiomalic acid, etc.

Step 604 of method 600 includes adding a glyme to the mixture for causing a precipitate to form in the mixture. An exemplary example of a glyme may be dimethoxyethane (DME). “Diglyme” refers to diethylene glycol dimethyl ether. Additional glymes include triglyme (triethylene glycol dimethyl ether) and tetraglyme (tetraethylene glycol dimethyl ether).

Glycol ethers can have, for example, a hydroxyl group, an alkyl group, or an ester group as a terminal group, while the other terminal group is typically an alky or phenyl group, but can also be a hydroxyl group. Glymes further include polyethylene glycols of various lengths.

In various inventive concepts described herein, the addition of glyme during synthesis of metallopolymer material may hinder metallopolymer formation and self-assembly thereby preventing formation of the expected metallophilic hydrogels. In one approach, immediately following the addition of glyme to the components of the metallopolymer, a metallogel precipitates as a viscous phase. The precipitated material exhibits rheological properties that may be dependent on moisture content. In some approaches, the precipitate material is able to absorb moisture from the surroundings of the material, i.e., the precipitate material is hygroscopic. The surroundings include the air, atmosphere, etc. surrounding the material.

Step 606 of method 600 includes collecting the precipitate. In some approaches, the metallopolymer material includes nanoparticles having a plurality of M-SR oligomers, where M is a metal, S is a sulfur of a thiol, and R is a functional group.

Step 608 of method 600 includes, optionally, equilibrating the concentration of the water in the metallopolymer material. In some approaches, the concentration of the water in the metallopolymer material may be equilibrated by placing the metallopolymer material in a chamber having a specific relative humidity. The specific relative humidity is generated by a saturated salt solution in the chamber.

In various approaches, control of the moisture content of the hygroscopic material may be achieved through equilibration in a relative humidity (RH) chamber containing saturated salt solutions.

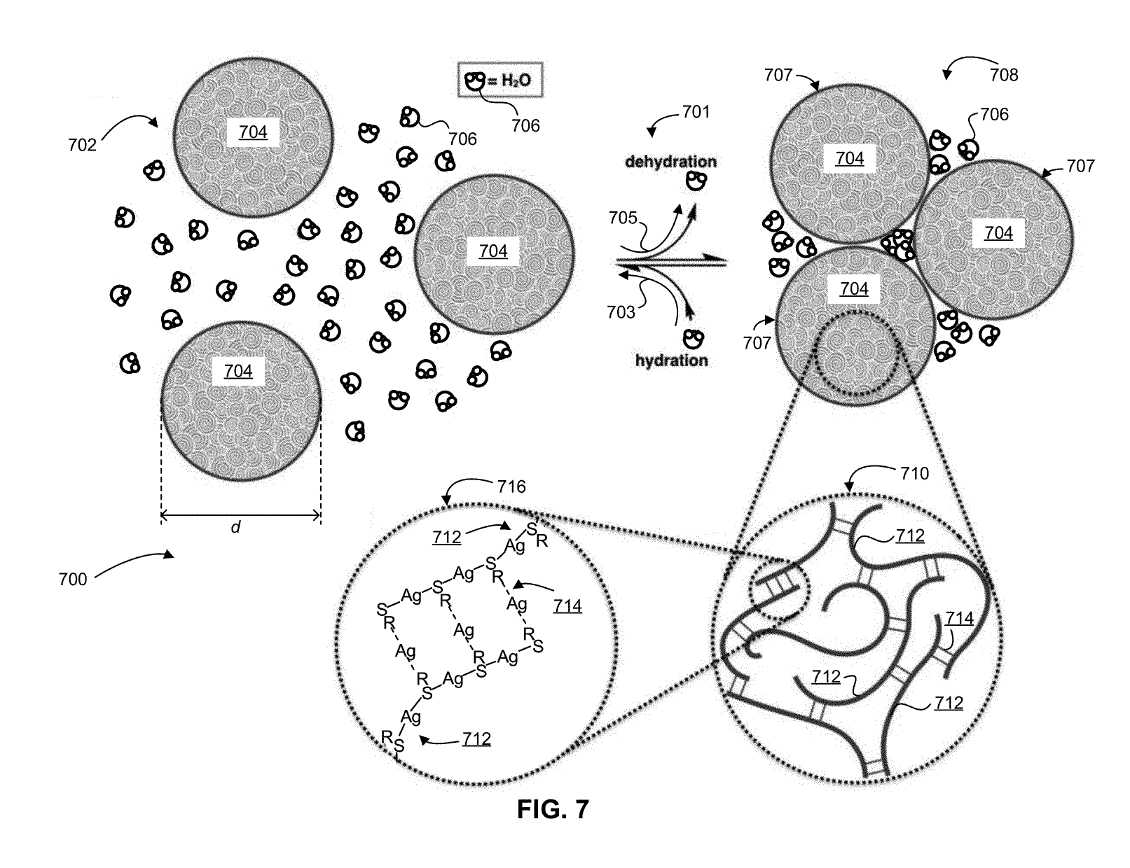

FIG. 7 depicts a schematic drawing of a metallopolymer material 700, in accordance with one embodiment. As an option, the present metallopolymer material 700 may be implemented in conjunction with features from any other embodiment listed herein, such as those described with reference to the other FIGS. Of course, however, such metallopolymer material 700 and others presented herein may be used in various applications and/or in permutations which may or may not be specifically described in the illustrative embodiments listed herein. Further, the systems of metallopolymer material 700 presented herein may be used in any desired environment.

In one embodiment, metallopolymer material includes a plurality of nanoparticles, a base, and water. In one exemplary approach, each of the nanoparticles includes a plurality of oligomer segments, where oligomer segments are coordinated to adjacent oligomer segments. Further, each of the oligomer segments includes a thiol and a metal. A coordination between oligomers may include an ionic bond, bridge, etc. between two molecules, for example, between a positive charge of a cation and a negative charge of an R functional group bound to a sulfur of a cysteine group.

FIG. 7 is a schematic diagram of the metallopolymer material, according to various aspects of inventive concepts described herein. In one approach, the metallopolymer material 700 includes nanoparticles 704 and water molecules 706. The system 701 shows a change in the structure of the metallopolymer material 700 during hydration 703 with the addition of water molecules 706. The hydrated metallopolymer material 702 has nanoparticles 704 in an excess of water molecules 706. In some approaches, the hydrated metallopolymer material 702 may be a liquid.

Alternatively, in some approaches, when the system 701 undergoes dehydration 705 such that water molecules 706 are removed, a dehydrated metallopolymer material 708 forms with the nanoparticles 704 assembling with the remaining water molecules 706 into a rigid structure. The base 707 of the metallopolymer material 700 may be located on the surface of the nanoparticles 704. In some approaches during dehydration 705 of the metallopolymer material 700, the presence of the base 707 on the surface of the nanoparticles 704 may be critical for assembly of the nanoparticles 704 with the water molecules 706 into a rigid structure. In some approaches, the dehydrated metallopolymer material 708 may be solid.

In some approaches, each of the oligomer segments may be a M-SR oligomer. As shown in the magnified view of a portion 710 of the nanoparticles 704, then nanoparticles 704 may be comprised of oligomers 712 that may be coordinated together through bridges 714.

In one approach, an R functional group of each of M-SR oligomers may be coordinated with a cation positioned between the M-SR oligomer and an adjacent M-SR oligomer. In one approach, the metal may be silver and the thiol includes cysteine. In one approach as shown in the, magnified view 716 of the oligomer coordination of the nanoparticle, the oligomers 712 show an Ag—S—Ag short oligomer segment coordinated to an adjacent oligomer through ion bridges that may link the Ag to the functional side chain (R) of the thiol (S).

For the purposes of this disclosure, the association (e.g., bond, coordination, etc.) of a sulfur (S) molecule of a cysteine with a silver (Ag) molecule may be defined as a silver-cysteine (Ag-Cys) unit. In one approach, a total of silver-cysteine (Ag-Cys, Ag—S) units in each nanoparticle may be in a range of about 2.5×10⁴ units to about 3.2×10⁶ units. In one approach, a total of silver-cysteine units in each nanoparticle may be in a range of about 2.5×10⁴ units to about 2.6×10⁷ units. In various approaches, the oligomer segments in each nanoparticle are discrete segments (e.g., truncated, broken, incomplete, small, short, etc.). In some approaches, each of the oligomer segments in the nanoparticle association therewith includes a portion of the total of silver-cysteine units of the associated nanoparticle. In other words, the total Ag-Cys units of each nanoparticle represent a plurality of segments of Ag-Cys units where each oligomer represents only a portion of the total Ag-Cys units of the associated nanoparticle.

In various approaches, the average diameter d of each nanoparticles 704 may be in a range of about 20 nanometers (nm) to about 200 nm. In some approaches, the average diameter d of each nanoparticle 704 may be in a range of about 20 nm to about 100 nm. In an exemplary approach, the average diameter d of each nanoparticle 704 may be about 40 nm.

In contrast to typical gels that trap up to 99% of their weight as solvent, metallogel samples as described herein solidify at low moisture content, according to various approaches. In a preferred approach, the concentration of the water of the metallopolymer material is at critical gel concentration. The critical gel concentration (CGC) is the critical concentration of water in the material that pinpoints where the metallopolymer crosses over from liquid like behavior to a solid like behavior. In one approach, the metallopolymer material may exhibit a form change at a critical gel concentration characterized by an inverse relationship of the elastic modulus of the metallopolymer material and the viscous modulus of the metallopolymer material. In one approach, a first form of the metallopolymer material has a first concentration of water in a range of greater than 0 to at most a critical gel concentration, where the elastic modulus of the first form of metallopolymer material is greater than the viscous modulus of the first form of the metallopolymer material. In some approaches, the metallopolymer material may have solid-like characteristics, in which the elastic modulus (G′) of the material is greater than the viscous modulus (G″) of the material.

In one approach, a second form of the metallopolymer material has a second concentration of water in a range of greater than the critical gel concentration to less than 100 wt % of total metallopolymer material, wherein the elastic modulus of the second form of metallopolymer is less than the viscous modulus of the second form of the metallopolymer material. In one approach, the metallopolymer material may have liquid-like characteristic, in which the viscous modulus (G″) of the material is greater than the elastic modulus (G′) of the material. The elastic modulus may also be defined as the shear modulus of the material.

In some approaches, the metallopolymer material may gel at a moisture content of 4.0 wt % water and 9 wt % water. In some approaches, the metallopolymer material may gel at a moisture content of greater than about 4.5 wt % water and less than about 8.0 wt % water. In preferred approaches, the metallopolymer material may gel at a moisture content between greater than about 4.9 wt % water and less than about 7.9 wt % water. In various approaches, the metallopolymer material is a metallogel. In some approaches, the metallogel may be a structure that is self-supporting, free-standing, etc.

In various approaches, the metallogel may be essentially amorphous. The metallogel may not form a crystalline structure.

In various approaches, an optimal moisture content to create the most rigid state may be when the moisture content is near the CGC of the material (around 5 wt %). In some approaches, the metallopolymer material having lower water concentration (between 0 wt % water and less than 4 wt % water) may be less rigid than a metallopolymer material having a water concentration around 5 wt %.

Without wishing to be bound by any theory, it is believed that water may play a structural role in network formation of the metallopolymer, in which dehydration away from the CGC removes water participating in strengthening the structure of the metallopolymer, and thus the broken network due to the removal of water results in a weakened material. Moreover, when water is added above 1 wt %, the water may fill void spaces in the microstructure thereby resulting in a more rigid microstructure. In some approaches, near the CGC of the metallopolymer, water may function as an anti-plasticizer, and then at a water content greater than 8 wt % of the metallopolymer material, water becomes a solvent to dissolve the same structures.

In some approaches, the CGC of the metallopolymer material may depend on the thiol used to form the metallopolymer. The water content of the metallopolymer material that results in a rigid microstructure of the material may depend on the thiol used to form the metallopolymer. In some approaches, the water content may be greater than 3 wt % to less than 5 wt % of total metallopolymer material to be the CGC of the material. In some approaches, the water content may be greater than 2 wt % to less than 5 wt % of total metallopolymer material to be the CGC of the material.

Likewise, for some approaches, increasing the water content suggests that water acts as a solvent thereby dissolving the material and resulting in a liquid. The water solubility of the metallopolymer structure may depend on the thiol used to form the metallopolymer material.

In some approaches, with increasing water content (up to about 100 wt % water), the viscosity of the metallopolymer material may decrease thereby exhibiting classic solvent behavior (a continuous change in viscosity with increasing water content). In sharp contrast, organic polymers typically demonstrate a step-wise change in viscosity with increasing water content (e.g., concentrated, semi-dilute, and dilute).

According to some approaches, the metallopolymer material may be in the solid form when the concentration of the water is in a range of greater than 0 wt % to less than 4.9 wt % of total material. In some approaches, the metallopolymer material may be a solid between 1.7 wt % to 4.9 wt % moisture content. In some approaches, the solid form of the metallopolymer material is a free-standing, self-supporting, etc. structure.

In some approaches, the solid metallopolymer material may have an elasticity (elastic modulus, G′) greater than approximately 10⁴ Pa. In an exemplary approach, the solid metallopolymer material may have an elastic modulus greater than approximately 10⁷ Pa to about 10⁹ Pa.

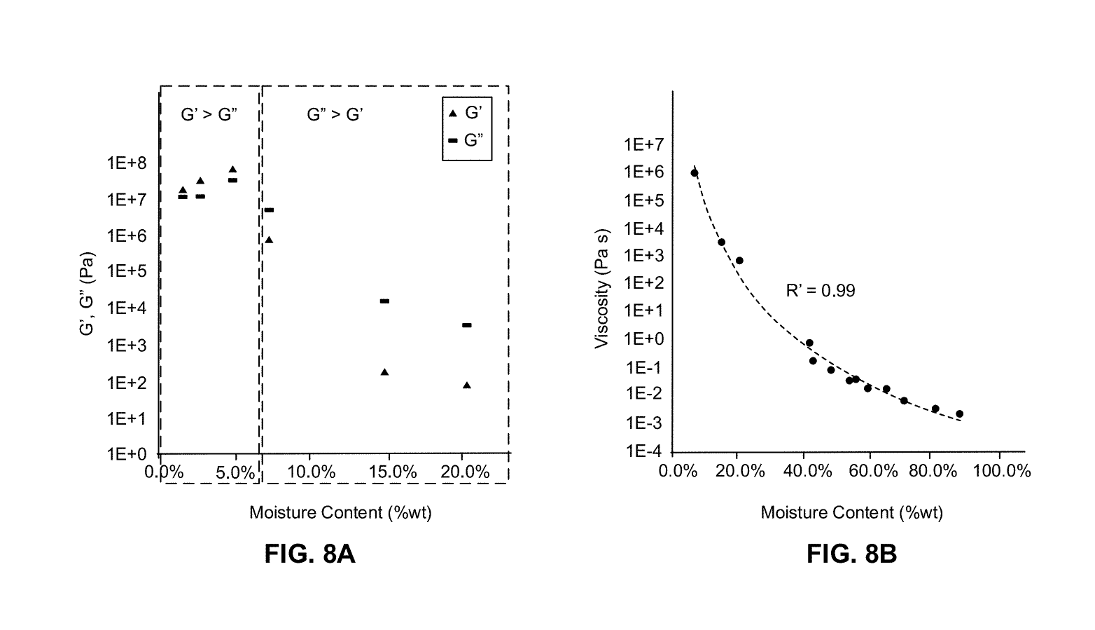

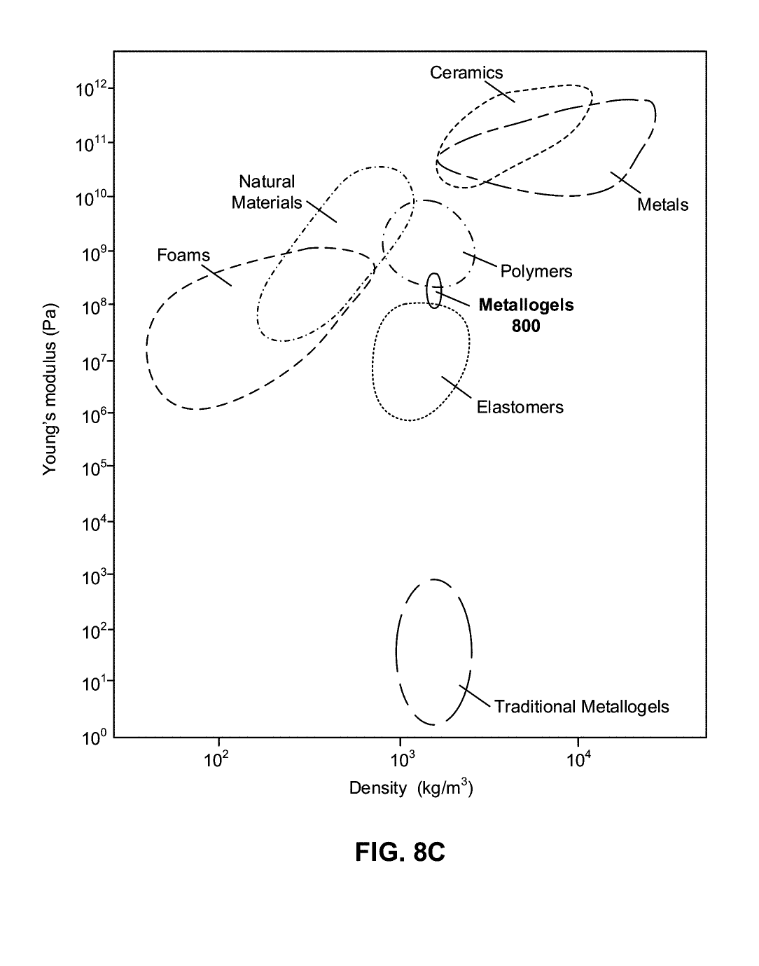

In sharp contrast, elasticity (elastic modulus, G′) of conventional metallophilic hydrogels of similar composition tend to be on the order of 10¹ Pa. In some studies, attempts to increase elasticity (G′) of metallophilic hydrogels have reached an upper limit of 10³ Pa (see FIG. 8C). Thus, traditional metallogels tend to have a Young's modulus in a range of 10¹ to 10³ Pa.

In some approaches, solid metallopolymer hydrogels formed by methods described herein may compare to common engineering material and further may demonstrate that the solid metallogel exhibits a modulus comparable to thermoplastics and rubbers. Thus, the metallogel preparation described herein may have potentially rendered metallogels available as engineering materials. Preferably, the Young's modulus of metallopolymer material is greater than the Young's modulus of elastomers In some approaches, the solid metallopolymer material may have a Young's modulus greater than 2.5×10⁸ Pa (0.25 GPa).

Bulk mechanical properties of metallopolymer gel material may be determined by a material's molecular architecture. In comparison to conventional metallophilic hydrogels formed through ideal self-assembly, the material described here in and conventional metallophilic hydrogels may be compositionally equivalent but structurally disparate.

In some approaches, metallophilic hydrogels may form as metal-thiolate polymers that assemble laterally into two-dimensional (2D) sheets. However, as shown herein, when the metallogel is precipitated with a coordinating antisolvent (e.g., glyme), a remarkable increase in shear modulus may indicate an emergence of novel structure-property relationship between the metallogel and the anti-solvent. Glyme may be referred to as a coordinating antisolvent when added during the synthesis of metallopolymers, according to one inventive concept. The “coordinating” role of glyme refers to glyme coordinating to a metal (e.g., Ag) to impede polymerization, thereby resulting in partially formed metallopolymers (e.g., oligomers). The “antisolvent” role of glyme refers to glyme being an inappropriate solvent for thiol thereby causing phase separation as indicated by the precipitation of the partially formed metallopolymers that include thiol components.

In some approaches, the presence of the glyme induces disorder to the assembly of the polymers, and further causes the precipitation of oligomers of the metallopolymer structure out of solution. It was surprising to the inventors, that a component, e.g., glyme, that disrupts the formation of ordered 2D sheets in the metallopolymer synthesis process could create a product that has a rigidity higher than the ordered 2D sheets. Without wishing to be bound by any theory, it is believed, that the glyme interrupts the formation of the metallopolymer structure and forms nanoparticles of various small sizes, and these nanoparticles associate to form a rigid structure at a certain critical level of water content. In various approaches, the size of the nanoparticles may be determined by the components of the metallopolymer, e.g., thiols, metals, etc. In one approach of forming an Ag-Cys metallopolymer material, a size of the nanoparticles may less than 45 nanometers in diameter to a smaller size of around 1 nanometer in diameter.

In conventional metallophilic hydrogels, 2D sheets stack through interactions between thiolate side chains extending from the top and bottom of the sheets to form microstructures, e.g., fibers, which may be observed by scanning electron microscopy (SEM). SEM studies of metallogel of the metallopolymer material as described herein have shown an absence of these microstructures may be characteristic of metallophilic hydrogels. In some approaches, a metallogel material may have a smooth and uniform appearance. In one approach, a dried metallogel material, cracks in the dried material may form due to low moisture content.

In some approaches, the metallogel material may be transparent to X-rays. In one approach, the metallogel material may be essentially completely amorphous.

In some approaches, the metallogel material may contain long-range order and comprise nanoparticles that may be completely amorphous. In some approaches, as the metallogel material dries, the network of nanoparticles of the material may become more ordered. In one approach, the self-assembly of large particles may be trapping smaller particles thereby resulting material being amorphous.

In some approaches, the metallopolymer material may be composed of a bimodal distribution of at nanoparticles. In one approach, the metallogel material may have at least two distinct populations of nanoparticles. The number of populations and the size of the nanoparticles in the populations may be determined by the individual components of the composition of the metallopolymer, e.g., thiols, metals, etc. In one approach, the metallogel material formed with silver and thiol may have two populations of nanoparticles having average diameters of about 40 nm and about 1 nm, respectively.

According to one inventive concept, the metallogel may be composed of amorphous nanoparticles instead of the crystalline sheets that tend to form under conventional self-assembly conditions of metallopolymer material. Without wishing to be bound by any theory, it is believed the structural difference may be due to the addition of a large molar excess of glyme at the onset of metallopolymer synthesis. Overwhelming the metallopolymer synthesis system with a coordinating antisolvent, such as glyme, may likely have two effects: a) glyme chelation to the metal, e.g., Ag, may impede metal-thiolate polymerization to form small oligomers, b) phase separation may correlate to precipitation of small oligomers as nanoparticles.

Without wishing to be bound to any theory, it is believed that the glyme may act as a coordinating anti-solvent that interacts differently with each component during synthesis of the metallopolymer material. For example, the glyme is a solvent for the metal, e.g., Ag, such that as a coordinating solvent the Ag-thiol polymer continues to form, however, as the Ag-thiol polymer grows, the thiol on the other hand increasingly becomes resistant to the presence of the glyme (and anti-solvent to thiol) and consequently, the growing polymer crashes and precipitates out of the glyme solution, thereby resulting in incomplete oligomers, e.g., nanoparticles, precipitating out of solution following the addition of glyme to the metallopolymer synthesis process.

The incomplete oligomers that precipitate out of solution following addition of glyme to the metallopolymer synthesis process may comprise only small number of repeat units of M-S. For example, and not meant to be limiting in any way, looking back to FIGS. 3A and 3B, the incomplete oligomers may include as few as 4 repeat units of M-S as shown in the metallopolymer material 302, 322. In one approach, the small oligomers may assemble as a microstructure through a part of the side chains of the small oligomers. In some approaches, the small oligomers may include nitrogen.

In some approaches, the microstructure of the metallopolymer may not include glyme. In one approach, the metallopolymer material may be essentially free of glyme. In one approach, the microstructure has essentially no glyme present in the structure. Furthermore, it was surprising that the criticality of glyme for formation of the microstructure of oligomers did not correlate with glyme being present in final microstructure of the metallopolymer. Indeed, removing glyme from the metallopolymer after formation of the microstructure, e.g., by vacuum, drying, etc., did not affect the metallopolymer material. Without wishing to be bound by any theory, the glyme seemed to remain in the water on the outside of the nanoparticles of the metallopolymer structure, and thus, could be removed by drying. Glyme did seem to be present inside the nanoparticles or part of the microstructure of the metallopolymer. In some approaches, a metallopolymer material may include M-SR oligomers in which the an R functional group of each of neighboring M-SR oligomers may be coordinated with a cation between neighboring M-SR oligomers. In one approach, the coordinating ion may be a metal cation.

In some approaches, the metallogel material may include nanoparticles having a metal and a thiol where the molar ratio of the metal to thiol is greater than 1:1. In one approach, the metallogel material may include a silver (Ag⁺) and thiol. In some approaches a molar ratio of Ag⁺ to thiol in the nanoparticles may be greater than 2:1. In an exemplary approach, an excess of 2.5× Ag⁺ over thiol (S) thereby suggesting the molecular network of the silver metallogel includes more than just 1:1 Ag:S in the nanoparticles. In some approaches, a prevalence of Na⁺ suggests that Na⁺ may also play a role in network formation.

Without wishing to be bound by any theory, it is believed that Ag⁺ may play two roles in the microstructure of the metallogel: a) Ag⁺ may constitute the metal-thiolate oligomer backbone of the metallogel, and b) Ag⁺ may also link oligomers together through coordination bonds to functional groups in the thiol side chain, thereby resulting in a supramolecular metal-thiolate oligomer network.

In some approaches, the role of water in a metallopolymer hydrogel having 4.9 wt % to about 7.4 wt % moisture content may indicate that water may serve as an antiplasticizer, such that water fills the void space within the hydrogel to increase rigidity of the microstructure. In one approach, as water is removed from the metallopolymer hydrogel to less than 5 wt % of total metallopolymer hydrogel, the nanoparticles of the microstructure interact with each other to form a rigid structure. As water is added to the metallopolymer hydrogel to a water content greater than 8 wt % of total metallopolymer hydrogel, the nanoparticles spread apart to become a liquid in a water solvent.

In some approaches, dried metallogel material, having low content of water, may have amine, NH₂, functional groups that may not significantly change with hydration of the material, thereby suggesting that the amine functional groups of the material may not play a role in interparticle network formation.

In some approaches, dried metallogel material, having low content of water, may have carboxylic, COO⁻, functional groups that may significantly change with hydration, thereby suggesting that the carboxyl groups may play a role in interparticle network formation within the metallogel material.

Without wishing to be bound by any theory, in some approaches, the dehydration, e.g., drying, removal of water, etc. of the metallogel, may indicate a more rigid bond, and the increased rigidity may likely be due to Na⁺ coordination. In one approach, the COO⁻ functional group of the nanoparticles may bind Na⁺ as the metallogel material dries, and thus implicates COO⁻ in a structural role for interparticle network formation.

Na⁺ may play a structural role in assembly of the microstructure of the metallogel, according to one approach. In metallogel material with a high content of water, the Na⁺ ions may be present as free, solvated ions. Whereas in other approaches when the dried metallogel material is in a solid state, e.g., water is removed, Na⁺ may be trapped in multiple coordination environments in random orientation to a single species within the metallogel material.

In one approach, as the metallogel material dries, Na⁺ ions may coordinate with COO⁻ carboxylic groups and glyme, thereby suggesting Na⁺ ions may be coordinated to one or two carboxylic groups. In one approach the Na⁺ ions may coordinate to glyme molecules during synthesis of the metallogel material.

In one approach, Na+ may exclusively coordinate to COO⁻ functional groups as the metallogel material dries. In one approach, Na⁺ ions on the nanoparticle surface may play a role in assembly by binding to cysteine COO⁻ groups. In various approaches, the Na+ may be present on the outside of the nanoparticles, rather than inside the nanoparticles. In one approach, the Na⁺ may be interacting with the COO⁻ groups on the surface of the nanoparticles. In a metallopolymer having a low water content, the Na⁺ ions interact with the COO⁻ groups of the nanoparticles and participate in the stacking of the nanoparticles. In a metallopolymer having a higher water content, the Na⁺ ions are released and flow around the particles.

A scenario in which Na⁺ ions engender reversible assembly of charged surfaces is not uncommon. In one approach, Na⁺ ions may be on the outside of the nanoparticles and may play a role in assembly of the microstructure of the metallogel material.

In some approaches, the nanoparticles of the metallogel material may be bound through extended COO—Na-water-Na—COO interactions between nanoparticles, such that an increased water content may solvate the Na⁺ ions, thereby releasing nanoparticles.

In some approaches, all cysteine in the microstructure of the metallogel material may be bound and exist in highly disordered sites. In some approaches, cysteine may be bound the an electron dense component, e.g., Ag. Within the microstructure of the dried metallogel material, cysteine may also be bound to two possible environments of carboxylic groups, COO⁻, a) cysteine-bound inside the nanoparticles, and b) cysteine-bound outside the nanoparticles, e.g., bonding to Na⁺.

In one approach, the microstructure of metallogel material includes the formation of the network through Ag—S bonds (Ag-Cys) that results in the creation of stereocenters in cysteine. Moreover, in one approach, there may be no free cysteine in the metallogel material.

Interestingly, glyme may not be present in the final material. In one approach, Ag may bond preferably to cysteine, and Ag may not bond to glyme. Further, glyme may not be a part of the nanoparticle network of the metallogel microstructure. In some approaches, glyme may not be present inside the metallogel network of nanoparticles.

In various approaches, glyme, e.g., DME, may play a role in synthesis of the metallogel material microstructure but may not be present in the final metallogel material. In various approaches, the addition of glyme is critical to form the short oligomers during metallopolymer synthesis, but in so doing glyme also impedes the synthesis process. In one approach, the addition of glyme during metallopolymer synthesis may prevent complete polymerization and instead precipitate amorphous nanoparticles of M(I)-SR oligomers into a dense, viscous phase. Glyme appears to hinder metallopolymer assembly thereby resulting in an amorphous network.

Residual glyme may exist in the final metallogel material, but does not seem to be a part of the nanoparticle network such that the residual glyme may be washed out or removed by vacuum. Furthermore, in some approaches, the Ag-Cys nanoparticles are stable in solution and assemble through COO—Na-water-Na—COO interactions as the material dries.

In one approach, the dried metallogel material exhibits mud-like rheology and is exceptionally rigid. In some approaches, the nucleation sites of the nanoparticles appear to be kinetically trapped and thus, may be prevented from growing. In one approach, the rigidity may be due to the bimodal distribution of particle diameters, thereby allowing the smaller particles to pack inside the void space of the larger particles. At this scale, the weak physical forces that hold the network together are incredibly strong together, since the surface area to volume ratio is so incredibly large compared to the microscopic assembly. In one approach, the large number of nanoparticles comprised of small oligomers form a more rigid network than a smaller number of large particles.

In some approaches, the weak forces of the rigid network may be easily broken by the addition of solvent, yet the same forces in the absence of solvent create a network having a large surface area to volume ratio such that the sum of these forces result in a strong, rigid material. In some approaches, the forces within the dried material may be stronger than covalently-bound elastomers.

In some approaches, the metallopolymer network may be comprised of amorphous Ag-Cys assemblies. At such a small size, the surface are to volume ratio is much higher than would be present in larger particles, resulting in many more physical bonds to hold the network together. This, in conjunction with the CGC of approximately 5% water, is likely the reason for the observed high rigidity. Hydrogels containing approximately 99% water have an abundance of water that can break the physical bonds holding the microstructures together, allowing them to easily slide past each other. At 4.9% water, the metallopolymer described herein may not have much water to plasticize the network, thereby resulting in a more rigid network.

Experiments

Table 1 lists various saturated salt solutions that created relative humidity environments for the metallogel material and lists the an equilibrium moisture content, e.g., water content, in the corresponding metallopolymer material.

In contrast to typical gels that trap up to 99% of their weight as solvent, metallogel samples listed in Table 1 solidify at low moisture content. Oscillatory strain rheology has shown that the metallogels of samples A-F in Table 1 cross over from liquid-like to solid-like behavior at low levels of moisture content. The concentration of water in a metallogel at which point a metallogel crosses over form liquid-like behavior to solid-like behavior may be defined as the critical gel concentration (CGC). Measuring the elastic (G′) and viscous (G″) moduli for each sample revealed the conditions at which a material is solid-like (G′>G″) or liquid-like (G″>G′).

As shown in FIG. 8A, the plots of the average elastic moduli, G′, and average viscosity moduli, G″, of each sample having a moisture content % (e.g., equilibration water wt % of Table 1) demonstrate two regions that exhibit solid-like and liquid-like behavior. The data indicate that Samples A, B, and C are solid (G′>G″) and Samples D, E, and F are liquid (G″>G′). Thus, without wishing to be bound by any theory, these data suggest that the metallopolymer material may gel at a moisture content between 4.9 wt % water (Sample C, closest solid sample to liquid) and 7.9 wt % water (Sample D, closes liquid sample to solid).

TABLE 1
Saturated salt solutions for relative humidities
(RH %) and resulting equilibrium water content
(wt %) in metallopolymer material samples.

| | | RH % | Equilibration Water |
|---|---|---|---|
| Sample | Salt | (at 20° C.) | (wt %) |
| A | LiBr | 6.61% | 1.69% |
| B | LiCl | 11.30% | 2.80% |
| C | KOAc | 23.10% | 4.88% |
| D | MgCl₂ | 33.10% | 7.37% |
| E | K₂CO₃ | 43.20% | 14.90% |
| F | Mg(NO₃)₂ | 54.40% | 20.20% |

As shown in FIG. 8A, the solid form of the metallopolymer material, with a moisture content between 1.7 wt % to 4.9 wt %, exhibits elasticity (elastic modulus, G′) greater than approximately 10⁷ Pa.

Interestingly, Sample C exhibits the highest modulus, and the samples weakened with decreasing moisture content, e.g., drying of the material, as shown in Samples B and A, respectively. These results suggest an optimal moisture content to create the most rigid state is when the moisture content is near the CGC of the material (around 5 wt %, sample C) and not when the lowest content of water is present (between 0 wt % water and less than 4 wt % water, samples A and B).

FIG. 8B depicts a plot of viscosity moduli of metallopolymer material as described herein over a wide range of moisture content (0 wt % to 100 wt % water). With increasing water content (approximately 100 wt % water), the viscosity of the metallopolymer material decreases thereby exhibiting classic solvent behavior (a continuous change in viscosity with increasing water content).

According to some approaches, the metallopolymer is a solid between 1.7 wt % to 4.9 wt % moisture content and exhibits elasticity (elastic modulus, G′) greater than approximately 10⁷ Pa. In sharp contrast, elasticity (elastic modulus, G′) of conventional metallophilic hydrogels of similar composition tend to be on the order of 10¹ Pa. In some studies, attempts to increase elasticity (G′) of metallophilic hydrogels have reached an upper limit of 10³ Pa.

To better understand the change in G′ of the metallopolymer hydrogel described herein, Equation 1 allows the conversion of G′ to Young's modulus (E′), a measure of uniaxial elastic deformation.

$${G}^{′} = \frac{{E}^{′}}{2 ( 1 + v )} \qquad Equation 1$$

In Equation 1, the relationship of elastic (e.g., shear) modulus, G′, and Young's modulus, E′, dependent on Poisson's ration (v). Applying Equation 1 to transform the G′ values of the metallopolymer hydrogel described herein, FIG. 8C illustrates the E′ value relative to density on an Ashby chart, as understood by one skilled in the art. As shown in FIG. 8C, Traditional Metallogels have a Young's modulus in a range of 10¹ to 10³ Pa. Considering most materials exhibit a Poisson's ratio between 0.3 and 0.5, an approximate range of E′ of the three solid metallogel samples, samples A, B, and C, would be in a range of about 4×10⁷ Pa to about 2×10⁸ Pa, respectively. As shown on an annotated Ashby chart in FIG. 8C, the E′ values of a solid metallopolymer hydrogel 800 compared to common engineering material demonstrates that the solid metallopolymer hydrogel 800, exhibits a modulus comparable to polymers (e.g., thermoplastics) and elastomers (e.g., rubbers). Thus, the metallogel preparation described herein may have potentially rendered metallogels available as engineering materials.

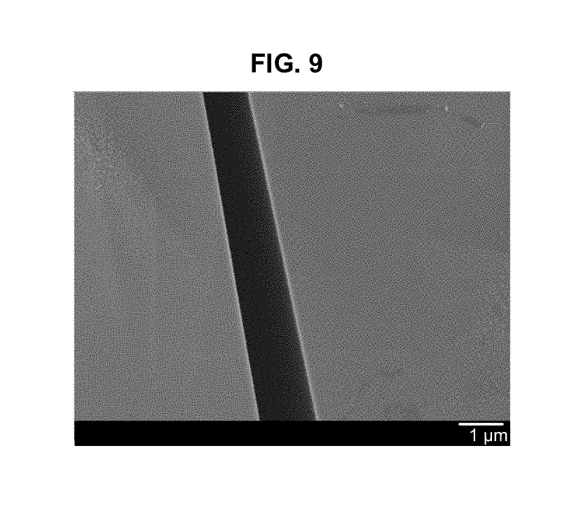

The scanning electron microscopy (SEM) image of FIG. 9 shows a dried metallogel material having a smooth and uniform appearance with a crack that forms in samples with less moisture content. The image of FIG. 9 is a magnified view of the dried material, such that the dried material having a low moisture content typically includes a plurality of cracks.

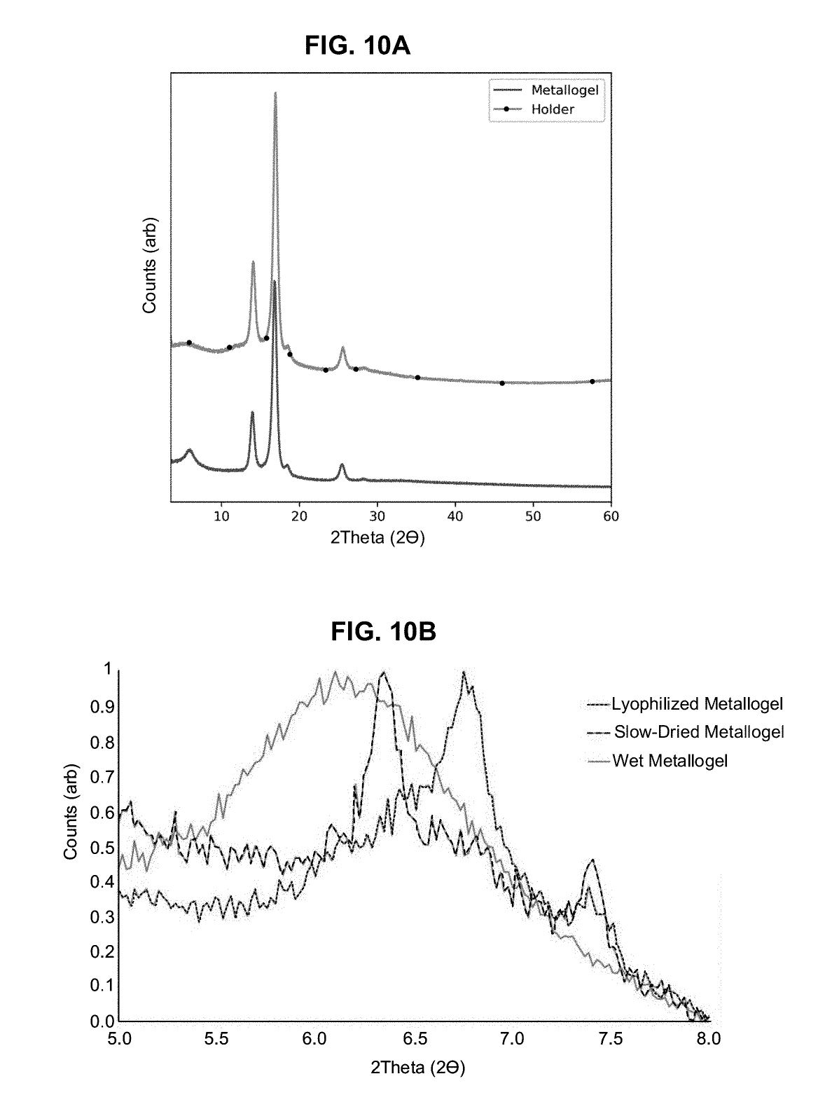

Plots of the metallogel material sample analyzed by X-Ray Diffraction (XRD) as depicted in FIG. 10A shows that the metallogel material may be largely transparent to X-rays. A plot of the polypropylene sample holder (●) shows the peaks generated by XRD analysis of sample holder, and the curve of a sample of the metallogel shows the peaks generated with the sample metallogel in the polypropylene sample holder. As shown, with the exception of a peak at approximately 6° 2θ, the metallogel material is essentially transparent to X-rays. Thus, the metallogel material may be essentially completely amorphous.

Furthermore, XRD analysis of metallogel material with varying levels of moisture content is shown in FIG. 10B. The plot of FIG. 10B represents a magnified view of the plot of FIG. 10A, where the 2theta (2θ) is in a range of 5.0 to 8.0. These curves suggests that the metallogel material may contain long-range order and that the nanoparticles of the metallogel may be completely amorphous. A closer look at how the peak at 6° 2θ changes with hydration shines light on what may be happening between the nanoparticles as they assemble. The peak of the wet metallogel at 6° 2θ sharpens to two fine peaks as the metallogel material dries, as shown with lyophilized metallogel having a peak at approximately 6.8° 2θ and a second peak at approximately 7.4° 2θ, and slow-dried metallogel having a peak at approximately 6.3° 2θ and a second peak at approximately 7.4° 2θ, These curves may reflect how the network becomes more ordered. Without wishing to be bound by any theory, it is believed the nanoparticles are amorphous and contain lots of Ag coordination modes in the network, thus the peaks within the broad peak in the wet metallogel may represent assembly of the large particles that may be trapping the smaller particles thereby resulting material being amorphous. Moreover, the possibly trapped smaller particles may explain the prolonged drying time for the metallogel to become dry.

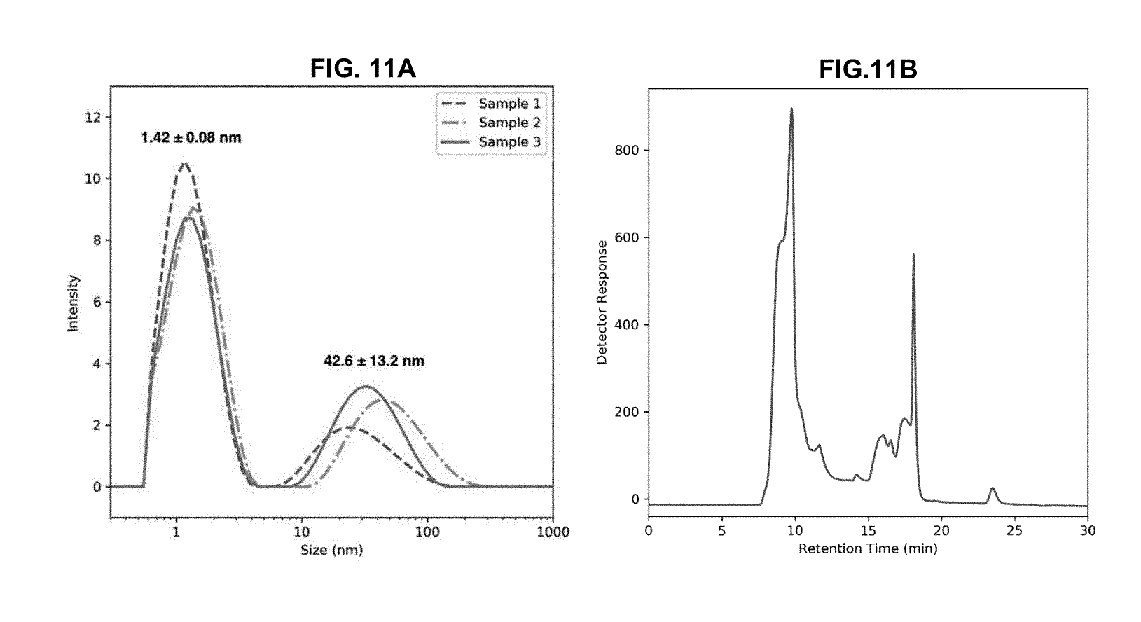

Dynamic light scattering (DLS) studies of the metallogel samples, as shown the plot in FIG. 11A, suggest the metallogel may be composed of a bimodal distribution of at particles having average diameters of 42.6±13.2 nm and 1.42±0.08 nm.

Gel permeation chromatography (GPC) with a refractive index detector, as shown in the plot in FIG. 11B, confirmed the presence of a bimodal distribution in the samples. However, correlation of chromatogram peaks to hydrodynamic radius is not possible without light scattering detectors or viscometry, and thus, concentration-dependent particle swelling or unanticipated interactions with the chromatography column may generate discrepancies between the modes of testing. However, the a bimodal distribution shown in the preliminary GPC studies (FIG. 11B) supports the diameters observed in the samples tested by DLS (FIG. 11A).

Inductively coupled plasma (ICP) analysis of the silver metallogel as described herein suggests molar ratios of 2.5:1:1 Ag:S:Na. A 2.5× excess of Ag⁺ over thiol (S) suggests the molecular network of the silver metallogel includes more than just 1:1 Ag:S metallopolymers, and the prevalence of Na⁺ suggests that Na⁺ may also play a role in network formation.

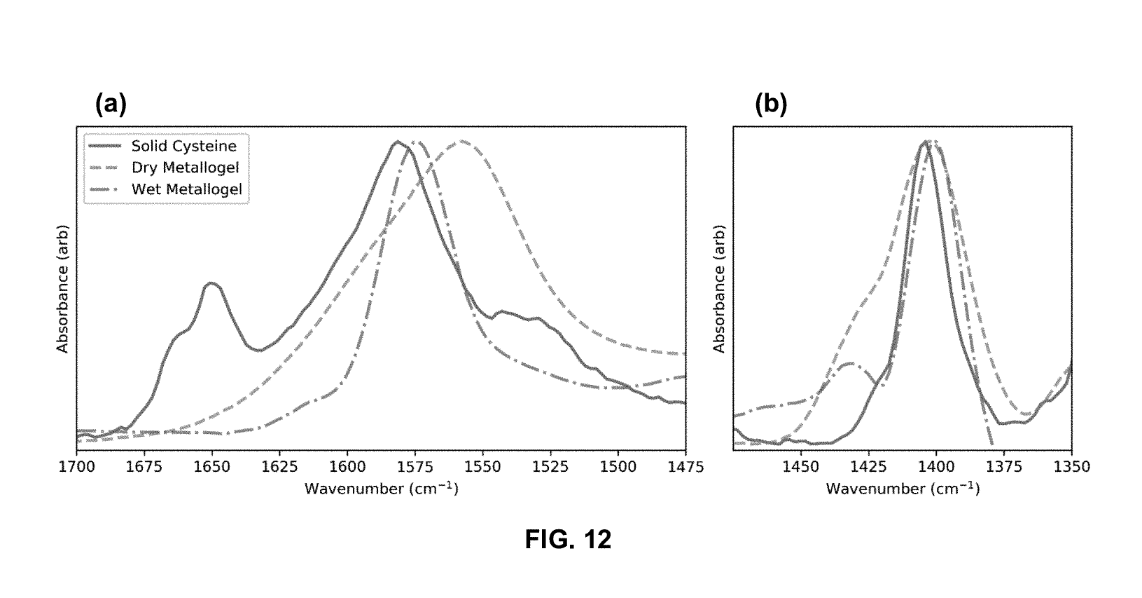

Fourier-transform infrared spectroscopy (FTIR) analysis of wet and dry metallogel material demonstrates which functional groups of the metallopolymer hydrogel change as water is removed (e.g., dehydration) and contribute to nanoparticle network formation, as shown in FIG. 12, part (a) and part (b).

The Solid Cysteine curve (solid line) of FIG. 12 shows pure cysteine exhibits peaks for COO⁻ and NH₂ stretches at 1600 cm⁻¹ (part (a)) and 1400 cm⁻¹ (part (b)), respectively. As sown in part (b), the peaks at 1300-1400 cm⁻¹ corresponding to NH₂ do not appear to significantly shift with hydration, which suggests that the amine may not play a role in interparticle network formation.

Now looking to the dried Dry Metallogel curve (dashed line) and the hydrated Wet Metallogel curve (dashed and dot line) of part (a) of FIG. 12, the peak at 1600 cm⁻¹ may represent combined C—C═O shifts to 1575 cm⁻¹ in the solvated metallogel (Wet Metallogel curve) and to 1500 cm⁻¹ in the dried metallogel (Dry Metallogel curve). Without wishing to be bound by any theory, a shift toward a lower wavenumber implies that the extent of reduced mass of the moiety has increased. In some approaches, the dehydration, e.g., drying, removal of water, etc. of the metallogel, may indicate a more rigid bond (e.g., any bond to COO⁻, COO—Na, etc.), and the increased rigidity may likely be due to Na coordination. The dried material of the solid metallogel (Dry Metallogel curve) thus may have the largest reduced mass due to COO—Na coordination in a rigid network. It is likely that there are multiple COO⁻ environments in the dried material that may contribute to the broad peak at 1550 cm⁻¹, as shown the Dry Metallogel. There likely exists some form of COO⁻ in the dried metallogel material similar to the COO⁻ present in the wet metallogel material (Wet Metallogel curve), which may contribute to the asymmetric tailing off towards high wavenumbers (greater than 1600 cm⁻¹, part (a)). The data suggests COO⁻ appears to bind Na as the material dries, and thus implicate COO⁻ in a structural role for interparticle network formation.

Nuclear magnetic resonance (NMR) of ²³Na analysis supports the theory that Na may play a structural role in assembly of the microstructure of the metallogel, according to one approach. The metallogel material demonstrates a sharp peak at approximately 0 ppm, similar to pure salt (NaCl) solutions in which the Na⁺ ions are free, solvated ions.

²³Na NMR analysis of the dried metallogel material showed a single, very broad peak with a chemical shift approaching 0 ppm. A single peak may indicate Na binds to one species across the sample, while a broad peak may suggest a great deal of disorder around this bond. Overall, these results suggest that as the metallogel dries, e.g., water is removed, Na⁺ may be trapped in multiple coordination environments in random orientation to a single species.

Results of the chemical shifts for Na⁺ ions coordinated with COO⁻ carboxylic groups and glyme suggest a large separation in the shifts for Na coordinated to one versus two carboxylic groups, and a smaller but still significant separation in the shift for Na coordinated to glyme. Without wishing to be bound by any theory, it is believed that the closest fit may be carboxylic group with Na, e.g., COO—Na. The close match in chemical shift suggests that Na may be exclusively coordinating to COO⁻ as the metallogel dries, and indicates that Na⁺ ions on the nanoparticle surface may play a role in assembly by binding to cysteine COO⁻ groups.

A change in peaks due to sample hydration suggests that Na⁺ ions may be on the outside of the nanoparticles and may play a role in assembly. In some approaches, the wet and dry ²³Na NMR spectra may look very similar to Na⁺ in between layers in clay at different hydration levels.

Further analysis with ¹³C NMR of the dried metallogel material shows very broad peaks all shifted upfield (data not shown), thereby suggesting that all cysteine may be bound and exist in highly disordered sites. Without wishing to be bound by any theory it is believed the shifts may be due to bonding to an electron dense component, e.g., Ag. In addition, cysteine may be binding to carboxylic groups, COO⁻, in different two

TABLE 2a
Predicted Binding Dissociation Energy (BDE) values of Singly
Bonded Groups to Na⁺ and Ag⁺ ions.

| | Singly Bound | | | | |
|---|---|---|---|---|---|
| Ion | DME | COO | S | NH₂—S | NH2—COO |
| Na⁺ | 0.225 | 0.334 | 0.196 | 0.168 | 0.107 |
| Ag⁺ | 0.609 | 0.923 | 1.514 | 1.231 | 0.449 |

TABLE 2b
Predicted Binding Dissociation Energy (BDE) values of Doubly
Bonded Groups to Na⁺ and Ag⁺ ions.

| | Doubly Bound | | | |
|---|---|---|---|---|
| Ion | COO—M—COO | COO—M—DME | S—M—S | S—M—DME |
| Na⁺ | 0.165 | 0.109 | 0.107 | 0.139 |
| Ag⁺ | 0.827 | 0.487 | 1.296 | 0.482 |

environments, a) cysteine-bound inside the nanoparticles, and b) cysteine-bound outside the nanoparticles, e.g., bonding to Na. FTIR analysis also exhibited possible evidence of two COO⁻ environments for cysteine.

Interestingly, glyme may not be present in the final material. The peaks for glyme in the ¹H NMR spectrum are shifted by 0.14 ppm, implying that all glyme is coordinated to either Na or Ag. Simulations of ¹H chemical shifts were also performed to aid interpretation of the observed change in the ‘H peaks for glyme upon formation of the metallogel.

Density functional theory (DFT) simulation studies, as shown in Tables 2a and 2b and FIG. 13, may allow prediction of the intermolecular associations. Thus, the DFT simulations of binding energies may predict possible scenarios for intermolecular bonding in the metallopolymer material, according to aspects of inventive concepts described herein. As shown in Table 2a for singly bound, bond dissociation energies (BDE) (in eV units) were calculated for both Na⁺ and Ag⁺ cations with the three functional groups of cysteine (molecular structure shown in part (a) of FIG. 13): thiol (S), carboxylic (COO), and amine (NH₂). In addition, as shown in Table 2b for doubly bound, BDE were calculated for both Na⁺ and Ag⁺ cations for several possible cysteine dimer configurations (COO-M-COO, S-M-S) coordinated through both cations. BDE for coordination of cations with glyme (DME) (molecular structure shown in part (a) of FIG. 13) were also calculated to predict the function of glyme as a coordinating antisolvent (BDE values listed in Tables 2a and 2b).

Part (b) of FIG. 13 shows a graphic of the BDE values of Table 2a that represent BDE for cations to functional groups of cysteine and glyme, singly bound with a bridged by a metal center. Of note, two different binding energies are shown for the amine group (NH₂—S, NH₂—COO) since the orientation of the H atoms of the amine group is different relative to the thiol (S) and carboxylic group (COO), the cations (Na⁺, Ag⁺ ) may coordinate in a bridged configuration between the amine and thiol or between the amine and carboxylic groups. As shown in the values in Table 2a and the graphical depiction of part (b), the thiol-bridged configuration (NH₂—S) is more strongly bound, while the carboxylic-bridged formation (NH₂—COO) is less strongly bound; and this effect is remarkably more significant for the Ag⁺ ion.

According to simulation studies, for all functional groups as listed in Table 2a and graphically depicted in part (b), Ag⁺ ions bound significantly more strongly than Na⁺ ions, thereby suggesting a strong preference for Ag over Na to be incorporated into the structural network. These studies indicated Ag⁺ ligand strength in the order of S>NH₂>COO⁻. Without wishing to be bound by any theory, it is believed that the excess Ag present in the metallopolymer material, as observed through ICP, that it is likely that some amount of all these ligand associations may be present in the metallopolymer material, and further, Ag⁺ may play a role in linking the Ag-Cys oligomers by other functional groups of cysteine.

The low predicted binding energies of Ag⁺ to glyme compared to other functional groups of cysteine suggests that incorporation of glyme into the structural network may be energetically unfavorable. Without wishing to be bound by any theory, it is believed that the excess of glyme added during synthesis may interact with an Ag⁺ coordination sphere at solvent exposure sites thereby impeding the formation of Ag-Cys bonds.

As shown in Table 2b and graphically depicted in part (c), binding energies (BDE) of cysteine dimers in bridged formations with cations Na⁺ and Ag⁺ are generally consistent with the singly bound results (as shown in Table 2a and part (b) of FIG. 13). Furthermore, Ag⁺ is energetically favorable Na⁺ for network forming intermolecular bonding.

Parts (d) and (e) of FIG. 13 graphically depict predicted calculations of BDEs in a vacuum or a solvent in order to represent how bonds may change when the system is dehydrated. Part (d) represents BDEs of all bonds to Na⁺ in a vacuum or solvent state and shows that in solvated state, one may predict that all bonds may be dissociated to Na⁺. Whereas for BDEs of all bonds to Ag⁺ in a vacuum or solvent state, as represented in part (e), one may predict that the bonds to Ag⁺ may remain stable in a solvent state. Thus, these results imply that while Na⁺ may be readily solvated, the Ag-Cys network may resist solvation.

In addition, these simulation studies show that glyme (DME) does not complex favorably with Ag⁺ or Na⁺, and, more specifically Ag⁺ complexes favorably with the functional groups of cysteine over glyme (DME). In experimental studies of glyme DME and NaNO₃ (DME+NaNO₃) as well as glyme DME and AgNO₃ (DME+AgNO₃) support this prediction. The DME-Na peaks agree with simulation and the metallogel material, thereby suggesting that Ag bonds preferably to cysteine since there is no evidence of Ag bonding to DME, e.g., DME-Ag.

As described herein, the networks of the metallopolymer material appear to include incomplete Ag-Cys oligomers that may precipitate as nanoparticles because of cysteine's insolubility in glyme. Dehydration draws the particles together that interact through weak physical forces. Without wishing to be bound by any theory, it is believed that COO bridges to Na are unlikely and thus water may be necessary to fill in the gaps and thereby water has a critical role in holding the network together.

Further NMR evidence suggests that DME may not be a part of the nanoparticle network of the metallogel microstructure. Correlation spectroscopy (COSY) analysis shows that DME and cysteine may not be interacting with each other. Moreover, DOSY analysis demonstrates that DME-Na in the metallogel material moves slightly slower than neat DME, which may be due to coordination of the DME to Na. In addition, the diffusion coefficient of Cys is much slower than DME-Na thereby implying that DME is not inside the metallogel network nanoparticles. Further, after removing all water from the system (e.g., pulling a vacuum on the material for several weeks), DME was not present in the dried material, thereby suggesting that any DME present may be soluble in water and is removed during dehydration.

In Use

Various inventive concepts described herein are useful for application as nanostructured catalysts and NIF targets. Furthermore, application of other metals to the inventive concepts described herein may lead to additively manufacturing high energy density (HED) materials and thermite.

Application of the various inventive concepts described herein include conductive inks, solar cells, battery electrolytes, transparent conductors, electronic devices, thermoelectrics, drug delivery, and biocompatible scaffolds.

The inventive concepts disclosed herein have been presented by way of example to illustrate the myriad features thereof in a plurality of illustrative scenarios, inventive concepts, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various inventive concepts have been described above, it should be understood that they have been presented by way of example only, and not limitation. Thus, the breadth and scope of an inventive concept of the present invention should not be limited by any of the above-described exemplary inventive concepts, but should be defined only in accordance with the following claims and their equivalents.

What is claimed is:

1. A metallopolymer material comprising,
a plurality of nanoparticles, a base, and water,
wherein each of the nanoparticles is comprised of a plurality of oligomer segments,
wherein oligomer segments are coordinated to adjacent oligomer segments,
wherein each of the oligomer segments is comprised of a thiol and a metal.

2. A metallopolymer material as recited in claim 1, wherein each of the oligomer segments is a M-SR oligomer.

3. A metallopolymer material as recited in claim 2, wherein an R functional group of each of M-SR oligomers is coordinated with a cation positioned between the M-SR oligomer and an adjacent M-SR oligomer.

4. A metallopolymer material as recited in claim 1, wherein a molar ratio of the metal to thiol in each of the oligomer segments is greater than 1:1.

5. A metallopolymer material as recited in claim 1 wherein the metal is silver, wherein a molar ratio of silver to thiol is greater than 2:1.

6. A metallopolymer material as recited in claim 5, wherein the thiol includes cysteine, wherein a total of silver-cysteine units in each nanoparticle is in a range of about 2.5×10⁴ units to about 3.2×10⁶ units, wherein the oligomer segments in each nanoparticle are discrete segments, wherein each of the oligomer segments in the nanoparticle association therewith comprises a portion of the total of silver-cysteine units of the associated nanoparticle.

7. A metallopolymer material as recited in claim 1, wherein an average diameter of each nanoparticle is in a range of about 20 nanometers to about 100 nanometers.

8. A metallopolymer material as recited in claim 1, wherein a concentration of the water is in a range of greater than about 4.5 weight % to less than about 8.0 weight % of total weight of material, wherein the metallopolymer material is a metallogel.

9. A metallopolymer material as recited in claim 1, wherein the metallopolymer material is essentially amorphous.

10. A metallopolymer material as recited in claim 1, comprising a bimodal distribution of particles.

11. A metallopolymer material as recited in claim 1, wherein a first form of the metallopolymer material has a first concentration of water in a range of greater than 0 to a critical gel concentration,
wherein the elastic modulus of the first form of the metallopolymer material is greater than the viscous modulus of the first form of the metallopolymer material.

12. A metallopolymer material as recited in claim 11, wherein a second form of the metallopolymer material has a second concentration of water in a range of greater than a critical gel concentration to less than 100 wt % of total metallopolymer material,
wherein the elastic modulus of the second form of the metallopolymer material is less than the viscous modulus of the second form of the metallopolymer material.

13. A metallopolymer material as recited in claim 1, wherein a concentration of the water in a range of greater than 0 weight % to less than 4.9 weight % of total material, wherein the metallopolymer material is in solid form.

14. A metallopolymer material as recited in claim 13, wherein the elastic modulus of the solid metallopolymer material is greater than 10⁴ pascals.

15. A metallopolymer material as recited in claim 13, wherein the Young's modulus of the solid metallopolymer material is greater than 0.25 gigapascals.

16. A metallopolymer material as recited in claim 1, wherein the metallopolymer material is essentially free of glyme.

17. A method of forming the metallopolymer material of claim 1, the method comprising:
forming a mixture comprising,
a metal salt dissolved in a portion of the water; and
the thiol dissolved in a second portion of the water having the base;
adding a glyme to the mixture for causing a precipitate to form in the mixture; and
collecting the precipitate.

18. A method as recited in claim 17, wherein a molar ratio of the thiol to the metal is at least three.

19. A method as recited in claim 17, wherein the thiol is selected from the group consisting of: glutathione, cysteine, and thiomalic acid.

20. A method as recited in claim 17, wherein the metal is selected from the group consisting of: gold, silver, and copper.

21. A method as recited in claim 17, wherein the glyme is selected from the group consisting of: dimethoxyethane, triglyme, tetraglyme, and polyethylene glycols.

22. A method as recited in claim 17, comprising equilibrating a concentration of the water in the metallopolymer material.

23. A method as recited in claim 22, wherein the concentration of the water in the metallopolymer material is equilibrated by placing the metallopolymer material in a chamber having a specific relative humidity, wherein the specific relative humidity is generated by a saturated salt solution in the chamber.
